(19) United States
(12) Patent Application Publication
(10) Pub. No.: US 2016/0121969 A1
(43) Pub. Date: May 5, 2016

(54) A HYDRAULIC OR PNEUMATIC DRIVE SYSTEM, AND A MOTOR AND A PUMP THEREFOR

(71) Applicant: GENIUS VELO LIMITED, Middlesex (GB)

(72) Inventor: Teklemichael Sebhatu, London (GB)

(73) Assignee: GENIUS VELO LIMITED, Middlesex (GB)

(21) Appl. No.: 14/896,360

(22) PCT Filed: Jun. 4, 2014
(86) PCT No.: PCT/GB2014/000213

§ 371 Date: Dec. 4, 2015

(30) Foreign Application Priority Data
Jun. 4, 2013 (GB) 1309972.6

(51) Int. Cl. B62M 19/00; F16H 39/01; F16H 39/02; F01B 3/00; F01B 3/04

(52) U.S. Cl. CPC B62M 19/00; F01B 3/0079; F01B 3/0085; F01B 3/04; F16H 39/02; F16H 39/01

(57) ABSTRACT

Hydraulic and pneumatic drive systems and fluid motors (12) and fluid pumps (10) therefor are disclosed. In such systems, rotation motion is converted to reciprocating motion or vice versa. In particular, a motion conversion means comprises a portion extending continuously and circumferentially around a central axis and extending in part longitudinally relative to the central axis, and a linking means, wherein the portion and the linking means are relatively rotatable about the central axis and a one of the linking means and the portion is fixedly coupled to a piston means, wherein the linking means and the portion are configured to cooperate whereby the reciprocating movement of the piston means causes relative rotary motion of the other of the portion and the linking means about said central axis. The other of the portion and the linking means may be coupled to a sleeve means to cause rotation thereof.

### FIELD OF THE INVENTION

The invention relates to a hydraulic or pneumatic drive system. The invention also relates to a motor and a pump for such a system.

### BACKGROUND

Hydraulic transmission or drive systems are known. Such systems may be complex or result in poor transmission efficiency. Also, in certain devices or machines in which transmission of a driving force is required, for example in a bicycle, no satisfactory hydraulic system is known.

A conventional transmission system of a bicycle comprises a chain and gears. There are various problems associated with these. For example, they are required to be lubricated and thus attract dirt, the lubricant and dirt often transferring to the rider. Also, the chain may come away from the gears. Although attempts have been made to implement hydraulic systems in bicycles, attempts have results in complex, heavy systems.

It is an object of the present invention to address the above-mentioned issues.

### SUMMARY OF THE INVENTION

In accordance a first aspect of the present invention, there is provided a hydraulic or pneumatic drive system, comprising: a) a pressure generation and transmission system utilizing fluid; b) a fluid motor comprising: a first cylinder means; a piston means, wherein the first cylinder means and a first end of the piston means located in the first cylinder means define a first chamber, and wherein the pressure generation and transmission system is coupled to the first cylinder means to cause alternating flow of fluid into and out of the first chamber, thereby to cause reciprocating movement of the piston means; motion conversion means comprising a non-linear part extending continuously and circumferentially around a central axis, and a linking means, wherein the non-linear part and the linking means are arranged for relative rotation about the central axis and a one of the non-linear part and the linking means is coupled to and fixedly disposed relative to the piston means; wherein the linking means and the non-linear part are configured to cooperate whereby the reciprocating movement of the piston means causes relative rotary motion of the other of the non-linear part and the linking means about said central axis.

The hydraulic motor efficiently converts reciprocating movement to rotary motion in the motor. The other of the linking means and the non-linear part is preferably able to be operatively coupled to an object to be rotated. In a bicycle, the rotary motion caused by pedaling can be transmitted to the rear of the bicycle to drive rotation of the rear wheel. This improves on the conventional chain and gear system as it removes need for chain and gears. Riders will not suffer from transfer of dirt to their legs. Since the system is closed, transmission efficiency is not hindered by dirt. Also, using such a hydraulic motor, a front wheel of a bicycle can be driven in place or in addition to the rear wheel. This may improve traction when cornering. Advantageously, the hydraulic motor may produces greater efficiency in comparison to a mechanical system.

The fluid motor may further comprise a second cylinder means, the second cylinder means and a second end of the piston means located in the second cylinder means defining a second chamber, wherein the pressure generation and transmission system is arranged to alternately cause flow of fluid into and out of the second chamber thereby to further cause reciprocating movement of the piston means.

The pressure generation and transmission system may comprise: a fluid pump for providing pressurised fluid, and a fluid transmission system operatively coupling the first and second fluid chambers to the fluid pump and arranged to enable fluid flow to the first and second chambers. The fluid transmission system may comprise a pair of fluid transmission lines each having one end sealingly connected to a respective one of the first and second fluid chambers and another end sealingly connected to the fluid pump. In this case, fluid may flow into and out of the respective first and second chambers via the same transmission line.

The fluid transmission system may comprise control means for selectively permitting or preventing flow of fluid into the first and second chambers through respective inlets thereto and out of the first and second chambers through respective outlets thereof, to cause reciprocating movement of the piston means.

The fluid transmission system may include a pressurisable fluid reservoir, each of the first and second chambers being coupled to the pressurisable fluid reservoir via a respective one of the inlets.

The pressurisable fluid reservoir may be coupled to the fluid pump, whereby operation of the fluid pump pressurises the pressurisable fluid reservoir. In this case, operation of the fluid pump pressurises the pressurisable fluid reservoir.

The control means may comprise actuating means coupled to the piston means, whereby movement of one of the first and second ends of the piston means to a predetermined distance into the respective one of the first and second chambers causes the actuating means to operate the control means to control flow of fluid whereby causing the other of the first and second ends to move into the other of the first and second chambers. In the same way, movement of the other of the first and second ends of the piston means to a predetermined distance into the other of the first and second chambers causes the actuating means to operate the control means to control flow of fluid, whereby to cause the one of the first and second ends to move into the one of the first and second chambers.

The control means has first and second states and the actuating means is arranged to change the control means between states, wherein in the first state: flow of fluid out of the first chamber through the outlet thereof is prevented, flow of fluid into the second chamber through the inlet thereto is prevented, flow of fluid out of the second chamber through the outlet thereof is permitted; flow of fluid into the first chamber through the inlet thereto is permitted; and in the second state: flow of fluid out of the second chamber through the outlet thereof is prevented, flow of fluid into the first chamber through the inlet thereto is prevented, flow of fluid out of the first chamber through the outlet thereof is permitted; flow of fluid into the second chamber through the inlet thereto is permitted.

The piston means may have an axis aligned with said central axis, and the reciprocating movement is along said central axis. Accordingly, the non-linear part and the piston means may be coaxial.

In an embodiment, the drive system may further comprise a sleeve means coaxial with the piston means, wherein the other of the non-linear part and the linking means is coupled to the sleeve means and fixedly disposed relative thereto, wherein the reciprocating movement of the piston means causes relative rotary motion of the sleeve means and the piston means about the central axis.

The sleeve means may have a substantially cylindrical inner surface, and the non-linear part is located in said surface, wherein the linking means projects from the piston means to engage with the non-linear part. The sleeve means and the non-linear part may be integrally formed. The sleeve means may, additionally or alternatively, be formed with the first and second cylinder means.

Alternatively, the linking means may project inwardly from the sleeve means and the non-linear part may be coupled to and disposed around the piston means. In this case, the non-linear part may be formed with a body of the piston means.

In another embodiment, the piston means is coupled to a drive shaft disposed coaxially with the piston means, so that rotation of the piston means causes corresponding rotation of the drive shaft and reciprocating movement of the piston means relative to the drive shaft on the central axis is permitted. In this case, the other of the linking means and the non-linear part are preferably fixed with respect to an exterior frame of a machine or vehicle.

The piston means may have an axial passage therethrough, the drive shaft being sealingly mounted through an aperture in an end of the first cylinder means and extending into said axial passage, wherein the drive shaft and the axial passage are together configured to so couple the drive shaft and the piston means.

The other of the linking means and the non-linear part may be coupled to a vehicle and is fixedly disposed with respect to the frame of the vehicle, and an end of the drive shaft extending from the first cylinder means is configured for coupled to a wheel of the vehicle, whereby rotation of the drive shaft causes corresponding rotation of the wheel.

The fluid motor further may comprise an outwardly extending arm configured to attach to a frame of the vehicle, thereby to fix the position of the other of the linking means and the non-linear part relative to the frame. For example, the arm may be configured to attach to a drop out of a bicycle frame with a bolt.

The one of the linking means and the non-linear part may be coupled to a vehicle and is fixedly disposed relative thereto, and the sleeve means may be operatively coupled to a wheel of the vehicle, whereby the rotary motion of the sleeve means causes rotary motion of the wheel. In this case said one may be coupled via the piston means to which the one is directly coupled.

The drive system may comprise support means restricting motion of the linking means to reciprocating movement parallel to the central axis. For example, the support means may be in the form of a support sleeve having a slot extending parallel to the central axis in which a part of the linking means, for example a bearing, can move back and forth.

The drive system may comprise movement restricting means preventing rotary motion of the other of the non-linear part and the linking means about the central axis, preventing reciprocating movement of a first of the linking means and the non-linear portion and permitting the reciprocating movement of a second of the linking means and the non-linear portion.

According to a second aspect of the present invention, there is provided a hydraulic or pneumatic drive system comprising: a) a fluid transmission system; b) a fluid pump comprising: a drive shaft rotatable about an axis thereof; a piston means; motion conversion means comprising a non-linear part extending continuously and circumferentially around a central axis, and a linking means, wherein the non-linear part and the linking means are arranged for relative rotation about the central axis, wherein the linking means and the non-linear part are configured to cooperate so that relative rotation causes relative reciprocating movement along the central axis, wherein a one of the non-linear portion and the linking means is coupled to the drive shaft whereby rotation of the drive shaft causes rotation of the one about the central axis; a first cylinder means, wherein the first cylinder means and a first end of the piston means located in the first cylinder means define a first chamber, and wherein the fluid transmission system is coupled to the first cylinder means to permit alternating flow of fluid into and out of the first chamber, wherein the piston means is arranged for reciprocating movement on or parallel to the central axis to cause fluid flow into and out of the first chamber; wherein the piston means is coupled to the other of the non-linear part and the linking means so that rotation of the one of the non-linear part and the linking means causes the reciprocating movement of the piston means in the first cylinder means.

The fluid pump may further comprise a second cylinder means, the second cylinder means and a second end of the piston means located in the second cylinder means defining a second chamber, wherein the fluid transmission system is operatively coupled to the second cylinder means to permit alternately flow of fluid into and out of the second chamber, wherein in use the reciprocating movement of the piston means causes fluid flow into and out of the second chamber.

The piston means may have an axis aligned with said central axis, the drive shaft has an axis aligned with the central axis, and the reciprocating movement is along said central axis. Preferably the piston means has a circular cross-section.

The one of the linking means and the non-linear part may be coupled to the piston means, wherein the piston means is coupled to the drive shaft so that rotation of the drive shaft causes corresponding rotary motion of the piston means about its axis and relative reciprocating movement of the piston means on the drive shaft is permitted, wherein the rotary motion of the drive shaft causes rotary motion of the piston means and thus the one of the linking means and the non-linear part, which causes reciprocating movement of the piston means on the drive shaft.

The piston means may have a passage therethrough, the drive shaft being sealingly mounted through an aperture in an end of the first cylinder means and extending into said passage, wherein the drive shaft and the passage are together configured to so couple the drive shaft and the piston means.

The one of the non-linear part and the linking means may be coupled to the piston means, the other of the non-linear part and the linking means being coupled to a frame of a machine or vehicle.

The non-linear part may be located in a sleeve means having a cylindrical inner surface having the central axis as the central axis thereof and extending around the piston means.

The drive system may further comprise a fluid motor, wherein the fluid transmission system is operatively coupled to the fluid motor to provide fluid to the fluid motor, thereby to drive the fluid motor. The fluid motor may be the fluid motor described above at b) in accordance with the first aspect of the invention and its optional features.

The fluid pump may further comprise movement restricting means preventing rotary motion of the other of the non-linear part and the linking means about the central axis, preventing reciprocating movement of a first of the linking means and the non-linear portion and permitting the reciprocating movement of a second of the linking means and the non-linear portion.

The fluid pump may advantageously be configured for location in a bottom bracket shell of such a machine or vehicle.

There may be provided a pedal driven machine or vehicle comprising the transmission system described above in accordance with the second aspect, wherein the first end of the drive shaft and a second end of the drive shaft extend from respective ends of the piston means, wherein the drive shaft ends are operatively attached to a first end of respective crank arms, wherein a second end of each crank arm is operatively attached to a respective pedal.

The drive shaft may be operatively coupled to a motor. The motor may be electric or comprise a combustion engine.

There may be provided a motorcycle or other motor vehicle including the drive system of the first or second aspects.

According to a third aspect of the present invention, there is provided a fluid motor for a pneumatic or hydraulic drive system, comprising: a piston means; a first cylinder means, wherein the first cylinder means and a first end of the piston means located in the first cylinder means define a first chamber, and wherein a pressure generation and transmission system is coupled to the first cylinder means to cause alternating flow of fluid into and out of the first chamber thereby to cause reciprocating movement of the piston means; motion conversion means comprising a non-linear part extending continuously and circumferentially around a central axis, and a linking means, wherein the non-linear part and the linking means are relatively rotatable about the central axis and a one of the linking means and the non-linear part is fixedly coupled to the piston means, wherein the linking means and the non-linear part are configured to cooperate whereby the reciprocating movement of the piston means causes relative rotary motion of the other of the non-linear part and the linking means about said central axis; a sleeve means rotatably mounted about the piston means and coaxial therewith, wherein the other of the non-linear part and the linking means is fixedly coupled to the sleeve means, wherein the reciprocating movement of the piston means causes relative rotary motion of the sleeve means about the central axis.

The fluid motor may further comprise movement restricting means preventing rotary motion of the one of the non-linear part and the linking means about the central axis, preventing reciprocating movement of the other of the linking means and the non-linear portion, and permitting the reciprocating movement of the other of the linking means and the non-linear portion, and the sleeve means.

The non-linear part may be coupled to the sleeve means and be located in a substantially cylindrical inner surface of the sleeve means. In this case the linking means projects from the piston means to cooperate with the non-linear part.

The non-linear part may alternatively be coupled to the piston means and extends around the piston means coaxially therewith. In this case the linking means projects from a substantially cylindrical inner surface of the sleeve means to cooperate with the non-linear part.

The fluid motor may further comprise a second cylinder means, the second cylinder means and a second end of the piston means located in the second cylinder means defining a second chamber, wherein the second chamber means is operatively coupled to the pressure generation and fluid transmission system for alternate fluid flow into and out of the second chamber means, which further causes reciprocating movement of the piston means.

An outer circumferential surface of the sleeve means may be adapted for coupling to an object to be rotated.

The piston means may be coupled to a frame of a vehicle to prevent movement thereof. In this case, the outer surface of the sleeve means is adapted for coupling to a wheel of the vehicle.

According to a fourth aspect of the present invention, there is provided a fluid pump, comprising: a drive shaft rotatable about an axis thereof; a piston means; a sleeve means rotatably mounted around the piston means and coaxial therewith; motion conversion means comprising a non-linear part extending continuously and circumferentially around a central axis, and a linking means, wherein the non-linear part and the linking means are arranged for relative rotation about the central axis, wherein the linking means and the non-linear part are configured to cooperate so that relative rotation causes relative reciprocating movement on the central axis, wherein a one of the non-linear portion and the linking means is coupled to the sleeve means whereby rotation of the sleeve means causes rotation of said one about the central axis; a first cylinder means, wherein the first cylinder means and a first end of the piston means located in the first cylinder means define a first chamber, and wherein the fluid transmission system is coupled to the first cylinder means to permit alternating flow of fluid into and out of the first chamber, wherein the piston means is arranged for reciprocating movement on or parallel to the central axis, the reciprocating movement of the piston means causing fluid flow into and out of the first chamber; wherein the piston means is coupled to the other of the non-linear part and the linking means, whereby rotation of sleeve means causes the reciprocating movement of the piston means.

The fluid pump may further comprises movement restricting means preventing rotary motion of the other of the non-linear part and the linking means about the central axis, and preventing reciprocating movement of one of the linking means and the non-linear portion.

The fluid pump may further comprise a second cylinder means, the second cylinder means and a second end of the piston means located in the second cylinder means defining a second chamber, wherein the fluid transmission system is coupled to the second cylinder means to permit alternately flow of fluid into and out of the second chamber, the reciprocating movement of the piston means causing fluid flow into and out of the second chamber.

The other of the non-linear part and the linking means may be coupled to the piston means, the piston means also being coupled to a frame of a machine or vehicle to prevent rotation about said central axis.

The non-linear part may be located in a sleeve means having a cylindrical inner surface having the central axis as the central axis thereof and extending around the piston means.

The drive system may further comprise a fluid motor, wherein the fluid transmission system is connected to the fluid motor to provide fluid thereto, thereby to drive the fluid motor.

According to a fifth aspect of the present invention, there is provided a method of retrofitting a fluid pump of a hydraulic drive system to a bicycle, wherein the fluid pump has a drive shaft extending therethough and is configured for location in a bottom bracket shell, comprising: securing the fluid pump in a bottom bracket shell and operatively coupling at least two fluid transmission lines extending to the rear and/or front hub; and operatively coupling a first end of each of a pair of crank arms to a respective end of the drive shaft and attaching a pedal to each second end of the crank arms.

The hydraulic drive system may comprise the hydraulic drive system described above, or include the fluid pump or motor described above.

In the drive systems, fluid motors and fluid pumps described above, the non-linear linking part is preferably a non-linear groove, and the linking means comprises a projection for engaging in the non-linear groove. As the non-linear groove and the projection relatively rotate about the central axis, the projection bears against the surface of the groove, causing relative reciprocating movement along the central axis. Conversely, as the non-linear groove and the projection move in relative reciprocal movement along the axis, the projection bears against the surface of the groove, causing relative rotary motion. In some embodiments, a fluid pump may be able to operate in reverse as a fluid motor and vice versa. In some embodiments this is not possible; in particular, the path of the non-linear groove may be designed for use in a fluid pump or a fluid motor, and prevent or impede use in the other.

The projection may comprise a bearing and means for retaining the bearing partially in the groove. This advantageously results in low friction between the projection and the groove.

According to a sixth aspect of the present invention, there is provided a hydraulic or pneumatic motor comprising: first and second cylinder means respectively defining first and second chambers, wherein each comprises at least one aperture operatively coupled to a fluid control system controlling inflow and outflow of fluid into the first and second chambers; a double-ended piston having a first end and a second end, wherein the piston is reciprocally moveable so that the first end and the second end move into and out of the first and second chambers to alternately increase and decrease the volume of the first and second chamber, respectively; control means for permitting or preventing flow of fluid into the first and second chambers through respective inlets thereto and out of the first and second chambers through respective outlets thereof to enable reciprocating movement of the piston.

The at least one aperture may comprise, for each of the first and second chambers, an inlet for inflow of fluid and an outlet for outflow of fluid, each inlet and outlet being operatively coupled to a respective fluid transmission line.

The fluid control system may include pressurisable fluid reservoir coupled to a hydraulic pump, whereby operation of the hydraulic pump pressurises the pressurisable fluid reservoir.

The control means may comprise actuating means coupled to the piston means, whereby movement of one of the first and second ends of the piston means to at least a predetermined distance into the respective one of the first and second chambers causes the actuating means to operate the control means to control flow of fluid whereby causing the other of the first and second ends to move into the other of the first and second chambers.

The actuating means may comprise: a member extending substantially parallel to an axis of the piston means along which the piston means reciprocates and arranged for reciprocating movement parallel to said axis; means coupling the piston means and the member, wherein when, in use, the first end of the piston means moves at least the predetermined distance into the first chamber, the piston means moves the member in a first direction parallel to said axis, and when, in use, the piston means moves at least the predetermined distance into the second chamber, the piston means moves the member in the second direction, wherein moving the member in the first direction beyond said predetermined distance operates the control means to control fluid flow to cause the piston means to move in the opposite direction.

The coupling means may comprise: first and second spaced lobes extending from the member; a projection extending from the piston means between the first and second lobes, wherein the piston means moves the member in the first direction by action of the projection on the first lobe, and the piston means moves the member in the second direction by action of the projection on the second lobe.

The control means may comprise first and second pivotable gate members shaped and disposed to control flow of the fluid into the first and second chambers, respectively, wherein the movement of the member is coupled to the first and second gate members for operative pivoting to control the fluid flow.

The controlling flow of fluid may comprise selecting between first and second states, wherein in the first state: flow of fluid out of the first chamber through the outlet thereof is prevented, flow of fluid into the second chamber through the inlet thereto is prevented, flow of fluid out of the second chamber through the outlet thereof is permitted; flow of fluid into the first chamber through the inlet thereto is permitted; and in the second state: flow of fluid out of the second chamber through the outlet thereof is prevented, flow of fluid into the first chamber through the inlet thereto is prevented, flow of fluid out of the first chamber through the outlet thereof is permitted; flow of fluid into the second chamber through the inlet thereto is permitted.

There may also be provided a drive system as described above, or the fluid motor described above, further comprising the features of the fluid motor of the sixth aspect. Notably, the fluid transmission system may be adapted for use in regulating the flow of fluid to the fluid motor, thereby controlling the speed of rotation output by the motor.

Embodiments of the invention can be implemented in vehicles or machines in which there is need for a drive force transmission system. In particular, embodiments may be implemented where torque is to be amplified or reduced.

### BRIEF DESCRIPTION OF THE FIGURES

For better understanding of the present invention, embodiments will now be described, by way of example only, with reference to the accompanying Figures in which:

FIG. 1A is a schematic diagram of a hydraulic drive transmission system in accordance with a general embodiment of the present invention;

FIG. 1B is a schematic diagram of a hydraulic drive transmission system in accordance with an alternative embodiment, including a pressure transmission system;

FIG. 2 is an exploded perspective view of a hydraulic pump for a bicycle in accordance with a specific embodiment;

FIG. 3 is an exploded side view of the hydraulic pump shown in FIG. 2;

FIG. 4 is a cross-sectional view of the hydraulic pump shown in FIGS. 2 and 3;

FIG. 5 is a perspective view of a piston of the hydraulic pump;

FIG. 6 is a perspective view of the hydraulic pump shown in FIGS. 2 and 3, in assembled form, with crank arms attached;

FIG. 7 is an exploded perspective view of a hydraulic motor for driving rotation of a wheel of a bicycle;

FIG. 8 is a perspective view of the hydraulic motor shown in FIG. 7, in an assembled form;

FIG. 9 is a cross-sectional view of the hydraulic motor;

FIG. 10 is a perspective end view of the hydraulic motor;

FIG. 11 is an exploded perspective view of a hydraulic pump for a motorcycle in accordance with a specific embodiment;

FIG. 12 is an exploded side view of the hydraulic pump shown in FIG. 11;

FIG. 13 is a perspective view of the hydraulic pump shown in FIG. 11, in assembled form;

FIG. 14 is a perspective view of a hub of a wheel of a motorcycle incorporating a motor in accordance with an embodiment;

FIG. 15 is a perspective view of the hub with parts removed to show parts of the motor;

FIG. 16 is another perspective view of the motor;

FIG. 17 is a cross-sectional side view of the hub;

FIG. 18 is another cross-sectional view of the hub;

FIG. 19 is a perspective view of parts of the motor comprising a pinion and a gate member;

FIG. 20 is a perspective view of other parts of the motor;

FIG. 21 is a perspective view of some of said other parts

FIG. 22 is a perspective exploded view of a hydraulic motor for heavy equipment;

FIG. 23 is a side view of the hydraulic motor shown in FIG. 22;

FIG. 24 is a side view of parts of the hydraulic motor shown in FIGS. 22 and 23 in assembled form;

FIG. 25 is a perspective view of a fluid pump in accordance with a another embodiment of the invention;

FIG. 26 is a side view of the fluid pump shown in FIG. 25;

FIG. 27 is an exploded perspective view of the fluid pump shown in FIGS. 25 and 26;

FIG. 28 is a side view of the fluid pump shown in FIGS. 25 to 27 in exploded form;

FIG. 29 is cross-sectional view of the fluid pump shown in FIGS. 25 to 28 in assembled form;

FIG. 30 is a side view of a hub assembly in accordance with an embodiment, and particularly for use with the fluid pump shown in FIGS. 25 to 29;

FIG. 31 is a perspective view of the hub assembly shown in FIG. 30;

FIG. 32 is an exploded perspective view of the hub assembly;

FIG. 33 is an exploded side view of the hub assembly;

FIG. 34 is a cross-sectional view of the hub assembly;

FIG. 35 is a perspective view of a fluid motor in accordance with another embodiment;

FIG. 36 is a side view of the fluid motor of FIG. 35;

FIG. 37 is a perspective view of a part of the fluid motor shown in FIGS. 35 and 36, the part preferably being formed of a single piece;

FIG. 38 is an exploded perspective view of the fluid motor;

FIG. 39 is a view of an end piece of the fluid motor;

FIG. 40 is a side exploded view of the fluid motor;

FIGS. 41 and 42 are perspective views of parts of the fluid motor.

### DETAILED DESCRIPTION OF EMBODIMENTS

Like parts are generally denoted by like reference numerals throughout.

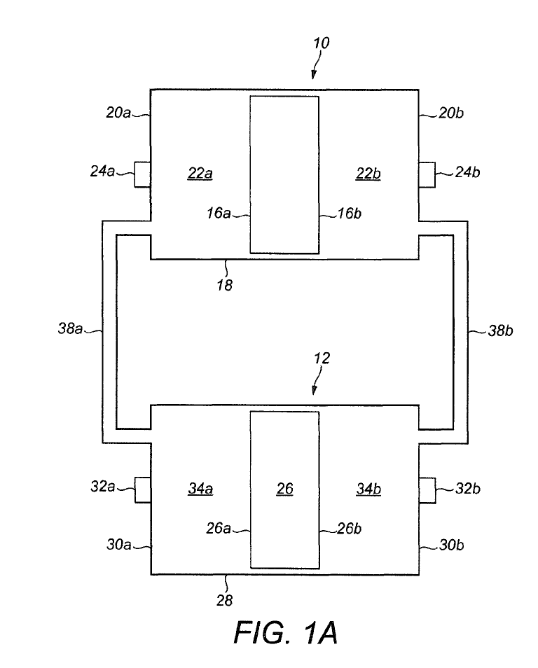

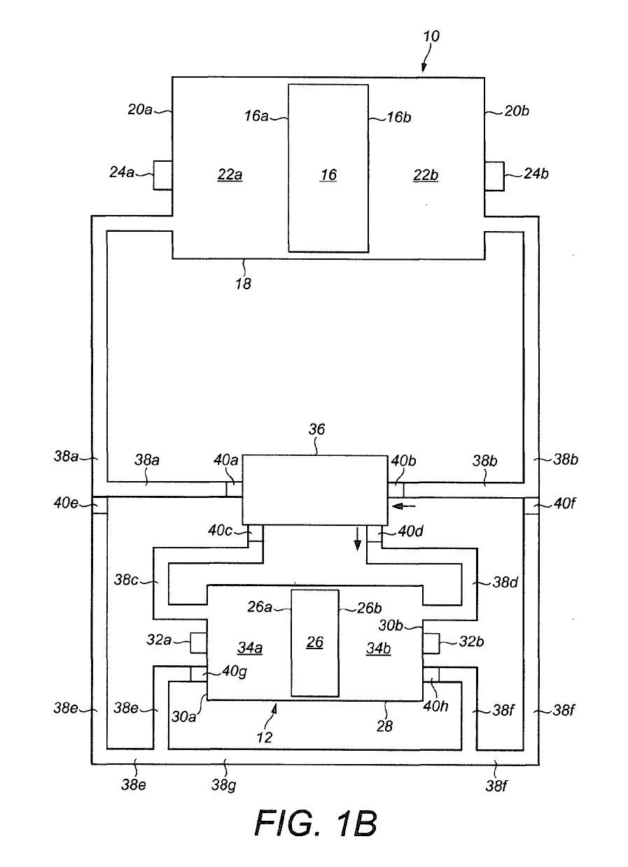

In the following, hydraulic drive or transmission systems in accordance with embodiments will first be described generally with reference to FIG. 1A or FIG. 1B. Hydraulic drive systems in accordance with specific embodiments will then be described, some comprising features of the systems described with reference to FIG. 1A or FIG. 1B.

Certain terminology will be used in the following description for convenience and reference only, and is not limiting. For example, term “cylinder” or “cylinder portion” is herein is used to refer to a housing defining at least one chamber suitable for containing fluid into which a piston end can sealingly extend. Although cylinders or cylinder portions shown in the Figures may have a circular or annular cross-section, this is not essential unless the context so dictates. The term “fluid” encompasses both liquids and gases. In the context of hydraulic systems, this term should be considered to be a substantially incompressible flowable material such as a liquid or gel, for example oil. In the context of pneumatic systems, this term should be considered to be a gas, typically an inert gas such as nitrogen or air.

The term “vehicle” includes any vehicle having a drive force transmission system, including, for example, bicycles, tricycles, motorcycles, cars, heavy goods vehicles, and heavy equipment. “Heavy equipment” refers to heavy-duty vehicles, in particular those specially designed for performing construction tasks, most frequently ones involving earthwork operations. Such vehicles are sometimes known as heavy vehicles, or heavy hydraulics, and include, non-exhaustively, bulldozers, diggers, cranes, loaders, soil compactors and tractors.

The hydraulic transmission system includes a hydraulic pump 10, a hydraulic motor 12, and a fluid transmission system connecting the pump 10 and the motor 12. The fluid is preferably oil, although alternative substantially incompressible fluids are suitable. The system is sealed, that is, egress of fluid from the system and ingress of air or contaminants from the exterior are prevented.

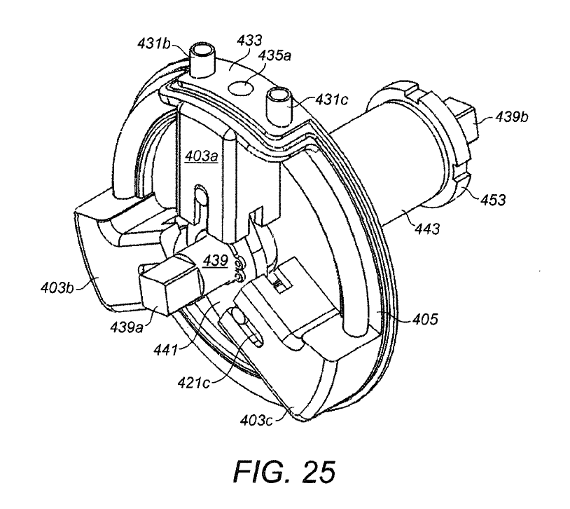

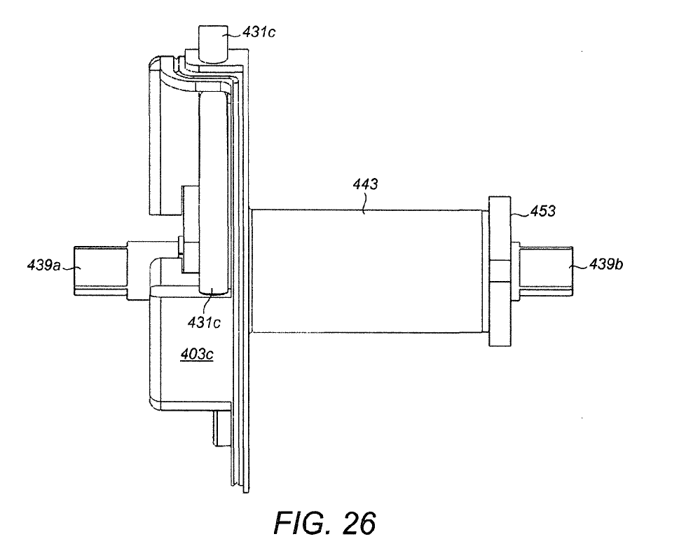

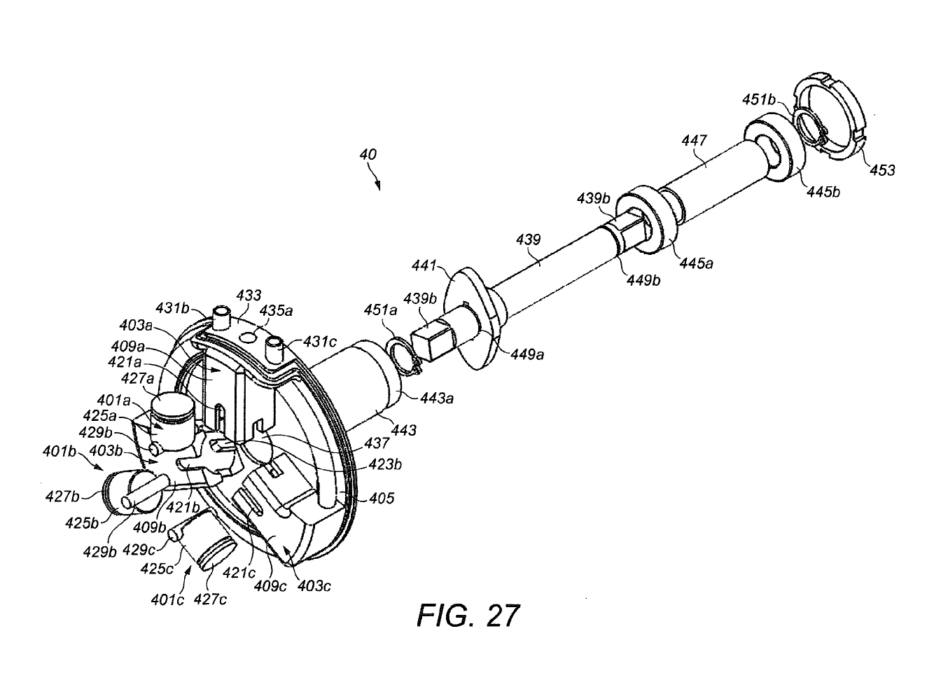

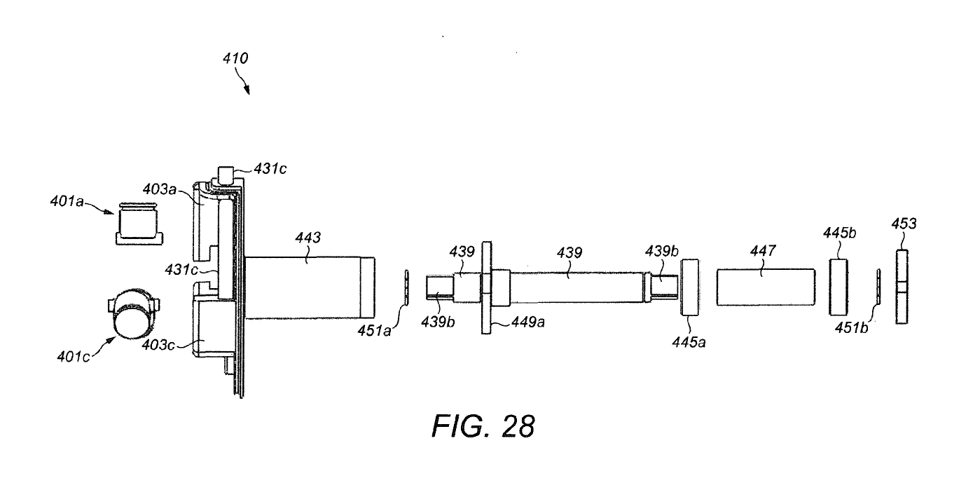

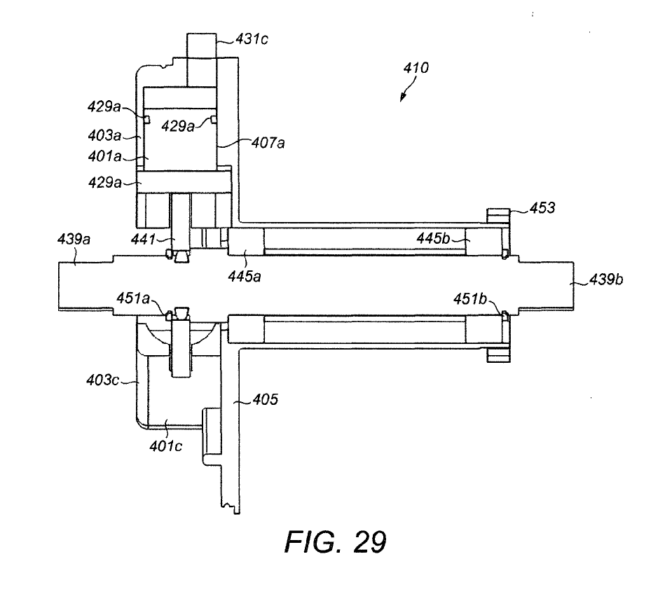

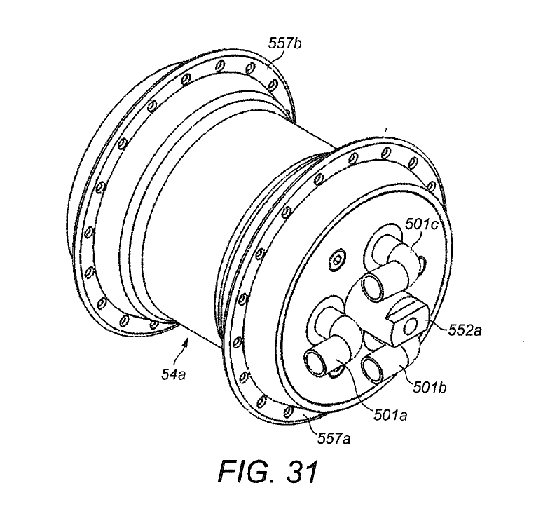

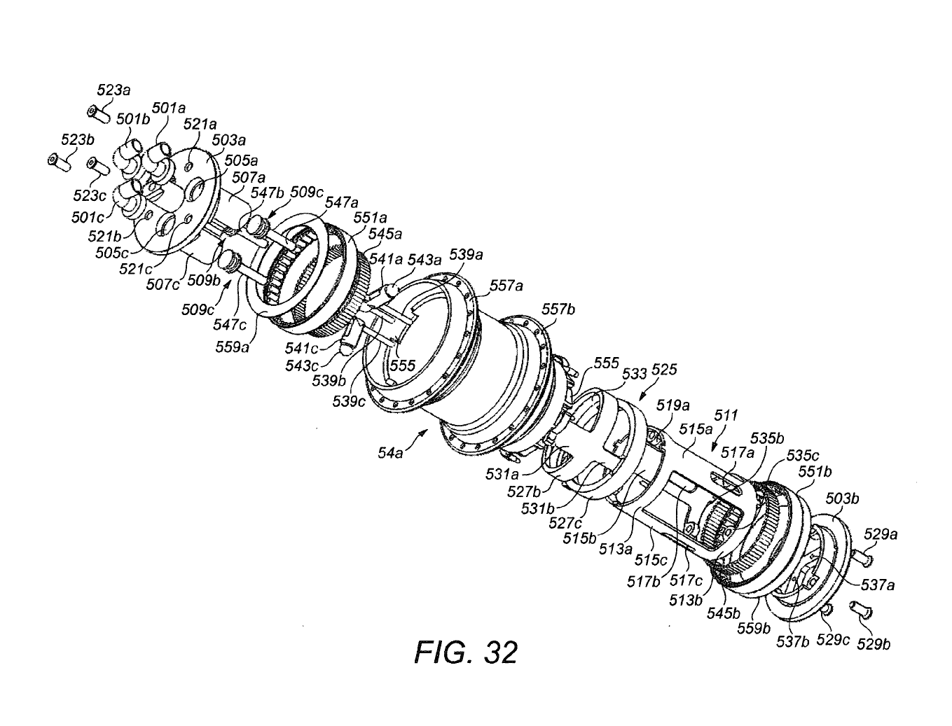

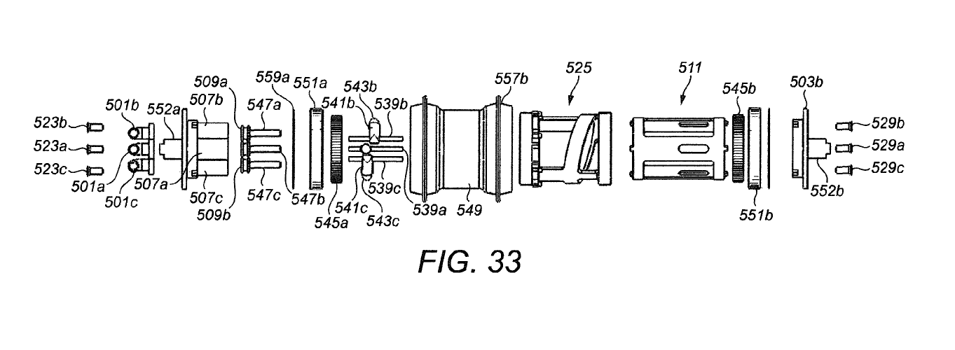

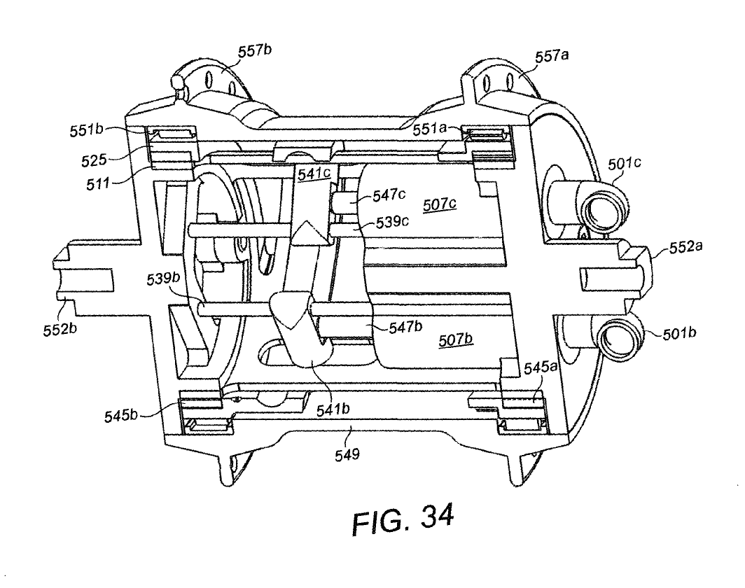

In the embodiments except those described with reference to FIGS. 25 to 34, the pump 10 is a reciprocating-type positive displacement pump including a first double-ended piston 16 and a first cylinder 18. The first cylinder 18 comprises a cylindrical outer sleeve closed at each end by first and second closures 20a, 20b. The first and second closures 20a, 20b of the first cylinder 18 and the first piston 16 have aligned apertures (not shown in FIG. 1A or 1B) through them, through which a first rotatable drive shaft 24 extends. The first piston 16 and the first drive shaft 24 are co-axial. The first piston 16 is moveable back and forth in the first cylinder 18 longitudinally with respect to the first drive shaft 24 to alternately exert a compressive force on fluid in a first chamber 22a between a first end 16a of the first piston 16 and the first closure 20a, and a second chamber 22b defined between a second end 16b of the first piston 16 and the second closure 20b. Peripheral edges of the first and second ends 16a, 16b of the first piston 16 are disposed flush against an interior surface of the outer sleeve so that the first and second chambers 22a, 22b are sealed at the juncture of the first piston 16 and the outer sleeve. Ends 24a, 24b of the first rotary drive shaft 24 extend respectively from the apertures in the first and second closures 20a, 20b. In some embodiments, only one of the ends may so extend. The first drive shaft 24, the first piston 16 and a first linkage (not shown) are together configured to cooperate so that rotational motion of the first drive shaft 24 causes repetitive reciprocating motion of the first piston 16, as will be described in greater detail below.

The motor 12 is of the same general design as the positive displacement pump. The motor 12 includes a second double-ended piston 26 and a second cylinder 28. The second cylinder 28 comprises an outer sleeve closed at each end by first and second closures 30a, 30b. The first and second closures 30a, 30b of the second cylinder 28 and the second piston 26 have aligned apertures (not shown in FIG. 1A or 1B) through them, through which a second rotatable drive shaft 32 extends. The second piston 26 and the second drive shaft are coaxial. The second piston 26 is moveable back and forth in the second cylinder 28 longitudinally with respect to the second drive shaft 32 to alternately exert a compressive force on fluid in a first chamber 34a defined between a first end 26a of the second piston 26 and the first closure 30a, and a second chamber 34b defined between a second end 26b of the second piston 26 and the second closure 30b. Peripheral annular edges of the first and second ends 26a, 26b of the second piston 26 are disposed flush against an interior surface of the outer sleeve so that the first and second chambers 34a, 34b are sealed at the juncture of the second piston 26 and the outer sleeve. Ends 32a, 32b of the second rotary drive shaft 32 extend respectively from the apertures in the first and second closures 30a, 30b. In variant embodiments only one of the ends 32a, 32b may so extend. The second drive shaft 32, the second piston 26 and a second linkage (not shown) are together configured to cooperate so that reciprocating motion of the second piston 26 causes rotational motion of the second drive shaft 32, as will also be described in greater detail below.

The first shaft 24 can be rotated by any suitable means to drive the piston 16 back and forth. For example, the first shaft 24 can be rotatably driven by an electric motor, by a combustion engine, by a windmill, by human power, such power including operation of an attached crank and pedal assembly, or otherwise. The second shaft 32 can be used to drive any device or machine for which a rotating shaft (the second shaft 32) is an appropriate driver. For example, the second shaft 32 may be coupled to a wheel to rotate the wheel.

In FIG. 1A, the pressure transmission system simply comprises first and second fluid transmission lines 38a, 38b. One end of the first line 38a is sealingly connected to the first closure 20a of the pump 10 at an aperture therein, and the other end of the first line 38a is sealingly connected to the first closure 30a of the motor 12 at an aperture therein, so that the first chamber 22a of the pump 10 and the first chamber 34a of the motor 12 are in fluid communication. One end of the second line 38b is sealingly connected to the second closure 20b of the pump 10 at an aperture therein, and the other end of the second line 38b is sealingly connected to the second closure 30b of the motor at an aperture therein, so that the second chamber 22b of the pump 10 and the second chamber 34b of the motor 12 are in fluid communication.

Although not shown in FIGS. 1A and 1B, each of the pump 10 and the motor 12 include a motion conversion arrangement for converting reciprocating movement to or from rotary motion. In accordance with embodiments, the arrangement includes a continuous non-linear portion in the form of a groove, and a linking means in the form of a projection. The groove extends circumferentially around an axis so that the distance of the groove from the axis is substantially constant. The groove extends in part longitudinally along its axis. The projection is engaged into the groove. The projection may just comprise a ball bearing in some embodiments. One of the projection and the groove may be fixedly disposed and the other be relatively rotatable about the axis of the groove. For example, where the projection is fixedly disposed relative to the groove and the groove is rotated about its axis, the projection forces the groove to reciprocate on its axis to permit the rotation to occur. In another example, the projection may reciprocate parallel to the axis of the groove, which requires rotary motion of the groove and the projection bears onto a surface portion of the groove causing the groove to rotate about its axis.

In use, rotation of the first drive shaft 24 causes reciprocating movement of the first piston 16. When the first piston 16 moves towards the first closure 20a, the volume of the first chamber 22a decreases and the pressure therein increases, so that fluid flows from the first chamber 22a into the first line 38a. Fluid from the first line 38a is then forced into the first chamber 34a of the motor 12, causing the second piston 26 to move towards the second closure 30b of the motor 12. Simultaneously, the volume of the second chamber 22b of the first piston 16 increases and the volume of the second chamber 34b of the second piston 26 decreases, so fluid is drawn into the second chamber 22b of the first piston 16 from the second transmission line 38b. When the first piston 16 moves towards the second closure 20b, the volume of the second chamber 22b decreases and the pressure therein increases, so that fluid flows from the second chamber 22b into the second line 38b. Fluid from the second line 38b is then forced into the second chamber 34b of the motor 12, causing the second piston 26 to move towards the first closure 30a of the motor 12. Simultaneously, the volume of the first chamber 22a of the first piston 16 increases and the volume of the first chamber 34a of the second piston 26 decreases, so fluid is drawn into the second chamber 22b of the first piston 16. Thus, as the first piston 16 reciprocates, the second piston 26 also reciprocates, thereby driving the second drive shaft 32.

It will be appreciated that the amount of fluid forced out of the first and second chambers 22a, 22b of the pump 10 when the piston 16 reciprocates should not exceed the amount that the first and second chambers 34a, 34b can receive, and the hydraulic transmission system is configured accordingly. Preferably, the amount of fluid forced from the first and second chambers 22a, 22b of the pump 10 each time the first piston 16 move back and forth is substantially the same as the amount of fluid required to move the second piston 26 the necessary distance back and forth for the second piston 26 to cause rotation of the second drive shaft 32.

In FIG. 1B, the fluid regulation system enables reciprocating motion of the first piston 16 to drive reciprocating motion of the second piston 26 irrespective of the amounts of the fluid forced from the first and second chambers 22a, 22b of the pump 10 during reciprocating motion relative to the amounts of fluid required to drive the reciprocating motion of the second piston 26. The system comprises a pressurised pressurised fluid reservoir 36, first to seventh fluid transmission lines 38a-38g, and first to eighth valves 40a-40h.

One end of the first fluid transmission line 38a is sealingly connected to the first closure 24a of the first cylinder 18 at an aperture therein. Another end of the first transmission line 38a is connected to the pressurised fluid reservoir 36. Thus, the first chamber 22a of the first cylinder 18 and the interior of the pressurised fluid reservoir 36 are connected so as to be in fluid communication. A first one-way valve 40a is located in the first transmission line 38a permitting flow of fluid from the first chamber 22a of the pump 10 to the pressurised fluid reservoir 36 and preventing flow of fluid in the opposite direction.

One end of the second fluid transmission line 38b is sealingly connected to the second closure 24b of the first cylinder 18 at an aperture therein. Another end of the second transmission line 38b is sealingly connected to the pressurised fluid reservoir 36. Thus, the second chamber 22b of the first cylinder 18 and the interior of the pressurised fluid reservoir 36 are connected so as to be in fluid communication. A second one-way 40b valve is located in the second transmission line 38b permitting flow of fluid from the second chamber 22b of the pump 10 to the pressurised fluid reservoir 36 and preventing flow of fluid in the opposite direction.

One end of the third transmission line 38c is sealingly connected to the first closure 30a of the second cylinder 28 of the motor 12 at an aperture therein. The other end of the third transmission line 38c is sealingly connected to the pressurised fluid reservoir 36. Thus the third transmission line 38c connects the first chamber 34a of the motor 12 and the interior of the pressurised fluid reservoir 36 so as to be in fluid communication. A third one-way valve 40c is located in the third transmission line 38c permitting flow of fluid from the pressurised fluid reservoir 36 to the first chamber 34a, and preventing flow of fluid in the opposite direction.

One end of the fourth transmission line 38d is sealingly connected to the second closure 30b of the second cylinder 28 of the motor 12 at an aperture therein. The other end of the fourth transmission line 38d is sealingly connected to the pressurised fluid reservoir 36. Thus the fourth transmission line 38d connects the second chamber 34b of the second cylinder 28 and the interior of the pressurised fluid reservoir 36 so as to be in fluid communication. A fourth one-way valve 40d is located in the fourth transmission line 38d permitting flow of fluid from the pressurised fluid reservoir 36 to the first chamber 34a of the motor 12, and preventing flow of fluid in the opposite direction.

A first end of the fifth transmission line 38e is sealingly connected to the first transmission line 38a in a section of the first transmission line 38a between the one-way valve 40a in the first transmission line 28a and the first chamber 22a of the pump 10. A second end of the fifth transmission line 38e is sealingly connected to the first chamber 34a of the motor 12 via a further aperture in the first closure 34a of the second cylinder 28.

A first end of the sixth transmission line 38f is sealingly connected to the second transmission line 38b in a section of the second transmission line 38b between the one-way valve 40b in the second transmission line 28b and the second chamber 22b of the pump 10. A second end of the sixth transmission line 38f is sealingly connected to the second chamber 34b of the motor 12 via a further aperture in the second closure 30b of the second cylinder 28.

A first end of a seventh fluid transmission line 38g is sealingly connected to the fifth transmission line 38e at a section between the first and second ends of the fifth transmission line 38e. A second end of the seventh fluid transmission line 38g is sealingly connected to the sixth transmission line 38f at a section between the first and second ends of the sixth transmission line 38f.

A fifth one-way valve 40e is located in the fifth transmission line 38e between the first end of the fifth transmission line 38e and the first end of the fifth transmission line 38e. This valve 40e permits flow of fluid from the interior of the fifth transmission line 38e to the interior of the first transmission line 38a, and prevents flow of fluid in the opposite direction.

A sixth one-way valve 40f is located in the sixth transmission line 38f between the second end of the sixth transmission line 38f and the first end of the sixth transmission line 38f. This valve 40f permits flow of fluid from the interior of the sixth transmission line 38f to the interior of the second transmission line 38b, and prevents flow of fluid in the opposite direction.

A seventh one-way valve 40g is located in the fifth transmission line 38e between the further aperture to the first chamber 34a of the motor 12 and the first end of the seventh transmission line 38g. This valve permits flow of fluid from the first chamber 34a into the fifth transmission line 38e, and prevents flow of fluid in the opposite direction.

An eighth one-way valve 40h is located in the sixth transmission line 38f between the further aperture to the second chamber 34b of the motor 12 and the second end of the seventh transmission line 38g. This valve 40h permits flow of fluid from the second chamber 34b into the sixth transmission line 38f, and prevents flow of fluid in the opposite direction.

In some embodiments, there may be a reservoir of fluid in the seventh transmission line 38g.

It will be appreciated that a conventional fluid pump may be used to drive the motor 12. Also, the pump 10 may be used to drive a conventional fluid motor. In embodiments incorporating the fluid transmission system described with reference to FIG. 1B, a pressurised fluid source drives the fluid motor 12—embodiments are not limited to use of the pump 10 or a conventional fluid pump to pressurise the fluid source. Further, a plurality of motors each in accordance with embodiments may be coupled to a pressurised fluid source. A plurality of pumps may also be used to pressurise the pressurised fluid source, thereby to ultimately drive one or more motors. Also, the fluid transmission system may be used to regulate rate of rotation of a fluid motor.

The motor 12 includes a control mechanism (not shown) that switches between first and second states. Iii a first state, when the second piston 26 moves towards the first closure 30a of the second cylinder 28, flow of fluid from the first chamber 34a into the fifth transmission line 38e is permitted, flow of fluid into the second chamber 34b from the fourth transmission line 38d is permitted, and flow of fluid from the second chamber 34b into the sixth transmission line 38f is prevented. Flow of fluid from the third transmission line 38c into the first chamber 34a is also prevented. Flow of fluid into the third transmission line 38c from the first chamber 34a is also prevented due to the third valve 40c. Flow of fluid from the pressurised fluid reservoir 36 into the fourth transmission line 38d and from the fourth transmission line 38d into the second chamber 34a is required to move the piston 26 towards the first closure 30a. The mechanism is such that when the first end 16a of the piston 16 reaches its closest predetermined distance to the first closure 30a, the fourth and fifth transmission lines 38d, 38e, that were open, close, and the third and sixth transmission lines 38c, 38f that were closed, open so that the control mechanism is in its second state.

In the second state, the second piston 26 moves towards the second closure 30b of the second cylinder 28. In this state the flow of fluid from the second chamber 34b into the sixth transmission line 38f is permitted, flow of fluid from the first chamber 34a into the fifth transmission line 38e is prevented, and flow of fluid from the third transmission line 38c into the first chamber 34a is permitted. Flow of fluid from the second chamber 34b into the fourth transmission line 38d is prevented due to the fourth valve 40d. Flow of fluid from the pressurised fluid reservoir 36 into the third transmission line 38a and from the third transmission line into the first chamber 34a is required to move the piston 26 towards the second closure 30b. The control mechanism is such that when the second end 16b of the piston 16 reaches its closest predetermined distance to the second closure 30b, the third and sixth transmission lines 38c, 38f, that were open, close, and the fourth and fifth transmission lines 38d, 38e that were closed, open, so that the control mechanism returns to the first state.

In use, the first shaft 24 is rotated, which causes repetitive reciprocating motion of the first piston 16 through transfer of force via the linkage to the non-linear groove.

When the first piston 16 moves towards the first closure 20a of the pump 10, the pressure in the first chamber 22a increases. Fluid is forced from the first chamber 22a into the first transmission line 38a and from that line through the first one-way valve 40a into the pressurised fluid reservoir 36. The fifth one-way valve 40e prevents flow of fluid into the fifth transmission line 40e. The pressure in the first transmission line 38a exceeds the pressure in the fifth transmission line 38e, and thus flow of fluid from the fifth transmission line 38e into the first transmission line 38a is substantially prevented. As the piston 16 moves towards the first closure 20a, the pressure in the second transmission line 38b becomes lower than the pressure in the sixth transmission line 38f. Fluid thus flows from the sixth transmission line 40f to the second transmission line 38b, with fluid flowing through the sixth valve 40f, and from the second transmission line 38b into the second chamber 22b of the pump 10.

When the first piston 16 moves towards the second closure 20b of the pump 10, the fluid transmission system operates in a mirror image sense. Fluid in the pressurised fluid reservoir 36 is thus maintained under pressure when the first piston 16 is reciprocating.

The motor 12 operates when the pressurised fluid reservoir 36 is adequately pressurised. When the motor 12 is in the first state, the second piston 26 moves towards the first closure 30a of the motor 12. When the second piston 26 reaches its closest predetermined position to the first closure 30a, the control mechanism switches the motor 12 to the second state. When the motor 12 is in the second state, the second piston 26 moves towards the second closure 30b of the motor 12. When the second piston 26 reaches its closest predetermined position to the second closure 30b, the mechanism switches to the first state. The second piston 26, the second drive shaft 32 and a linkage (not shown) are configured to cooperate so that linear reciprocating motion of the second piston 26 longitudinally with respect to the second drive shaft 32 drives rotation of the second drive shaft 32.

Thus, in summary rotary motion of the first shaft 24 causes linear reciprocating motion of the first piston 16. The reciprocating motion of the first piston 16 causes reciprocating motion of the second piston 26 due to the operation of the fluid transmission system. The reciprocating motion of the second piston 26 causes rotary motion of the second shaft 32.

It will be understood that in the transmission system the ratio of angular speeds of the first shaft 24 and second shaft 32 can be chosen by determining the parameters of the system. For example, the ratio is dependent upon the relative size of the surface areas of the first and second ends of the first and second pistons perpendicular to the direction of the respective piston's movement. The system also results in torque magnification where the angular speed of rotation of the second shaft 32 is less than the angular speed of rotation of the first shaft 24, and in torque reduction where the angular speed of rotation of the first shaft 24 results in a higher angular speed of the second shaft 32.

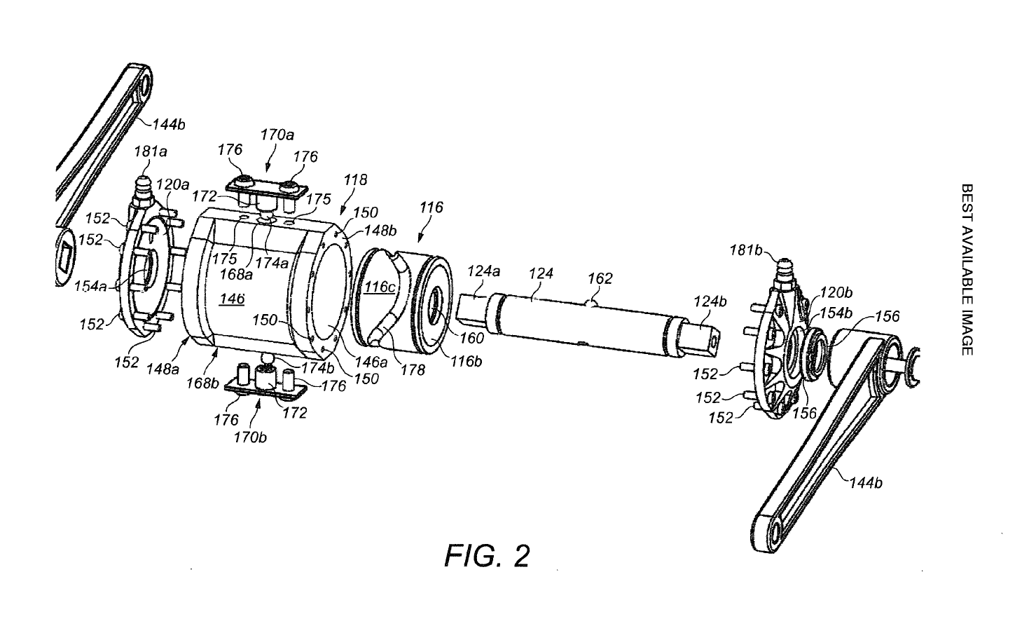

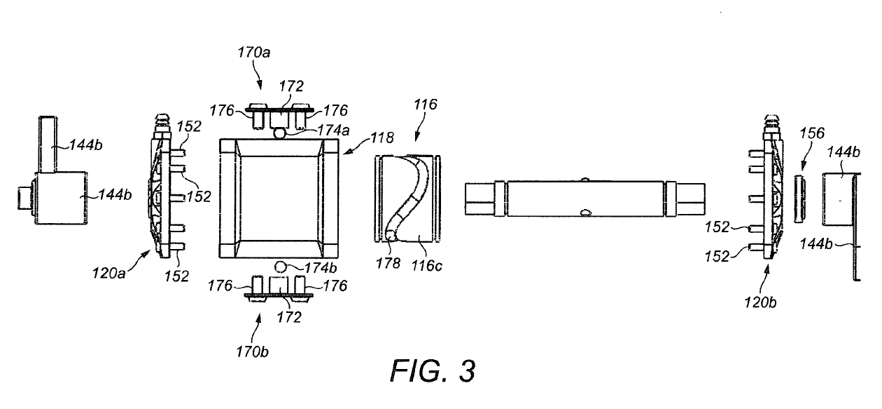

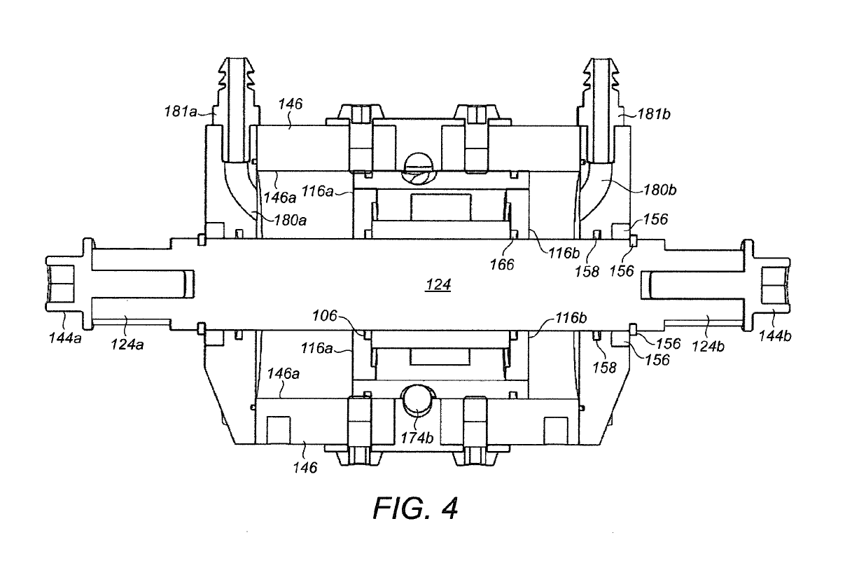

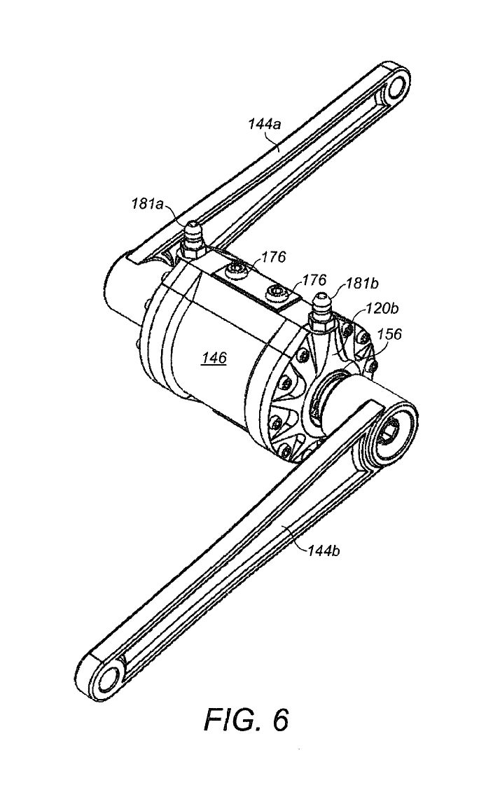

With reference to FIGS. 2 to 6, a hydraulic pump 110 in accordance with a specific embodiment is described. The pump is for a hydraulic drive transmission system of a bicycle. The hydraulic pump comprises a first piston 116, a first cylinder 118, a rotatable drive shaft 124, and a linkage.

Although a bicycle is not shown in the Figures, it should be understood that the pump 110 is for location in a bottom bracket shell of a bicycle. The bottom bracket shell defines a passage orthogonal to the general plane of a bicycle through which a bottom bracket is conventionally securely located so that ends of a rotatable drive shaft extend orthogonally relative to said plane. Crank arms can be secured to the ends of the drive shaft. In a typical bicycle, a seat tube, a down tube and chain stays all join to the bottom bracket shell. In the present embodiment, the pump 110 is for location in place of a conventional bottom bracket. When so located, ends 124a, 124b of the rotatable drive shaft 124, which is often referred to as a “spindle” in the art, each extend from the bottom bracket shell orthogonally relative to the general plane of the bicycle and each end is configured for secure attachment of a respective appropriately configured crank arm 144a, 144b. A pedal (not shown) is attached to the other end of each crank arm 144a, 144b.

Bottom bracket shells are conventionally one of a number of standard sizes in cross-sectional inner diameters and length, so that a bottom bracket of corresponding diameter and suitable for the shell length can be secured in the shell. The dimensions of the shell for receiving the pump 110 may differ from standard sizes to accommodate the pump 110.

In an alternative embodiment, the pump 110 is adapted to have dimensions such that it fits in a conventional bottom bracket shell of standard size. This facilitates retrofitting of the hydraulic transmission system to bicycles not specifically designed for use with the hydraulic transmission system.

The first cylinder 118 includes a cylinder body 146 and first and second closures 120a, 120b. The cylinder body 146 has a cylindrical inner surface 146a defining a cylindrical space having circular cross-section, has an outer longitudinal surface shaped to fit in the bottom bracket shell, and has first and second annular end faces 148a, 148b. Each of the first and second closures 120a, 120b is attached to the cylindrical body 146 to close a respective end of the cylinder body 146. This is achieved by each closure 120a, 120b being provided with peripheral apertures that align with corresponding threaded apertures 150 in a respective annular end face 148a, 148b of the cylindrical body 146. Each of the first and second closures 120a, 120b is sealingly attached to the respective end face 148a, 148b with screws 152 extending through the peripheral apertures into the threaded apertures 150. Alternative ways of attaching the first and second closures 120a, 120b to the ends faces 148a, 148b are suitable and will be apparent to the skilled person.

Each of the first and second closures 120a, 120b has a respective central hole 154a, 154b located therethrough, that is, they are annular. The first drive shaft 124 extends through the cylindrical space in the cylinder body 146. Ends 124a, 124b of the first shaft 124 extend through the holes 154a, 154b and are attached to the crank arms 144a, 144b. The first shaft 124 is secured so as to prevent lateral movement but allow rotation, and the first and second chambers 122a, 122b are sealed at the juncture between the first drive shaft 124 and the closures 120a, 120b by a bearing assembly and a self lubricating O-ring 156. Egress of fluid and ingress of contaminants thus prevented.

Due to the bearing assembly and the O-ring 156, friction between the first shaft 124 and the closures 120a, 120b is low. Bottom brackets with various sealing and bearing arrangements are commercially available, and it is foreseeable that the skilled person may adapt embodiments of the present invention to include such arrangements. The precise nature of such sealing and bearing arrangements is beyond the scope of the present description.

The first piston 116 has a passage 160 therethough from a first end surface 116a to a second end surface 116b. The piston 116 is substantially cylindrical and is axially mounted on the first drive shaft 124 with the first drive shaft 124 extending through the passage 160, that is, so that the cylindrical piston 116 and the first drive shaft 124 are co-axial. The first piston 116 and the first drive shaft 124 are engaged so that when the drive shaft 124 rotates, the piston 116 rotates therewith, and so that the piston 116 can slide longitudinally back and forth on the first drive shaft 124.

In greater detail, first shaft 124 is of substantially circular cross-section, but includes a plurality of circumferentially spaced recesses in its circumferential surface. Bearings 162 are located in the recesses and project from the circumferential surface. The inner surface of the passage 160 has a plurality of grooves 164 extending lengthwise with the passage 160 parallel to the axis of the piston 116. The projecting bearings 162 form a male spline and the grooves 164 form a female spline matching the male spline. Accordingly, when the first piston 116 is mounted on the first drive shaft 124, any torque is transferred from the first drive shaft 124 to the piston 116, and the piston can move longitudinally on the first drive shaft 124. The bearings 162 advantageously achieve low friction movement. O-rings 166 prevent passage of fluid from one side of the piston 116 to the other side through the passage 160.

One bearing 162 is shown projecting from each recess, but it will be appreciated that more or fewer bearings may be present. Also, in the present embodiment, two recesses are spaced around the first drive shaft 124, each having a bearing in it, but greater or fewer recesses may be provided, with the grooves of internal surface of the piston 116 corresponding in number. Alternatively, the first piston 116 and the first drive shaft may be otherwise engaged, provided torque is transferred from the first drive shaft 124 to the first piston 116 and the first piston 116 can move longitudinally back and forth on the first drive shaft 124. In a simple alternative, this may be achieved by the first drive shaft 124 having a square or polygonal cross-section and the piston passage 160 having a matching cross-section.

The cylinder 118 has first and second holes 168a, 168b extending from the cylindrical interior surface 164a to the exterior. A respective bearing mount 170a, 170b including a projecting portion 172 extends into each hole 168a, 168b. Each bearing mount 170a, 170b is configured to support a linkage which is in the form of a respective ball bearing 174a, 174b that partially projects from an end of the projecting portion 172, so that the bearing extends beyond the cylindrical inner surface 164a of the cylindrical body 164, but the bearing mount 170a, 170b does not. Each bearing mount 170a, 170b is fixed to the cylindrical body 164 by means of a pair of threaded apertures 175 in the cylindrical body 164 and screws 176 that engage in the apertures 175 to attach the bearing mount 170a, 170b to the cylindrical body 164. The first and second holes 168a, 168b and respective bearing mounts 170a, 170b are located on diametrically opposing sides of the cylindrical body 164, and are located centrally with respect to the length of the body. This results in the ball bearings 184 projecting inwardly in respectively diametrically facing directions.

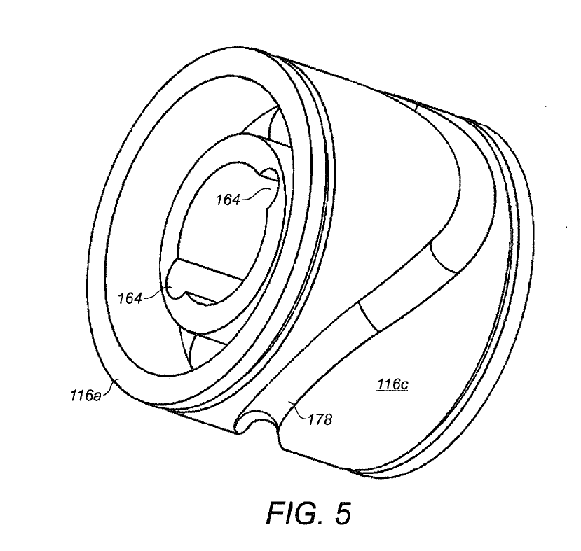

As best seen in FIG. 5, the first piston 116 has an outer cylindrical surface 116c including a linking portion in the form of a continuous non-linear groove 178 extending continuously around the cylindrical surface 116c in a wave-like manner. The cross-sectional shape of the piston 116 matches the cross-section of the interior space of the cylinder 118. When the piston 116 is located in the cylindrical body 164, the ball bearings 174a, 174b extend into the non-linear groove 178 and cause lengthwise movement of the first piston 116 on the first shaft 124. As the first piston 116 is rotated by rotation of the first shaft 124, a respective portion of the non-linear groove is always in contact with each ball bearing, the ball bearings 174a, 174b requiring the first piston 116 to move back and forth on the first shaft 124 in order for the first piston 116 and thus the first shaft 124 to rotate.

It will be appreciated that there need only be a single ball bearing 174a, 174b, or there may be a greater number. However, the number of ball bearing needs to take into consideration the shape of the non-linear groove 178, that is, the number of troughs and peaks. Where only a single ball bearing is present, there may only be a single peak and trough. Where there are two peaks and two troughs, there may be one or two ball bearings. Where there are three peaks and three troughs, there may be one, two or three appropriately located ball bearings. In addition, the linkage need not be in the form of a ball bearing; instead a lug may project from the interior surface of the cylinder body.

The first and second end 116a, 116b, the first and second closures 120a, 120b and the cylindrical body 164 together respectively define first and second chambers 122a, 122b. Each closure 120a, 120b has an aperture 180a, 180b therein for inflow and outflow of fluid. The apertures are sealingly connected to the nozzles 181a, 181b for connection of the first and second fluid transmission lines in the manner indicated schematically in FIG. 1A.

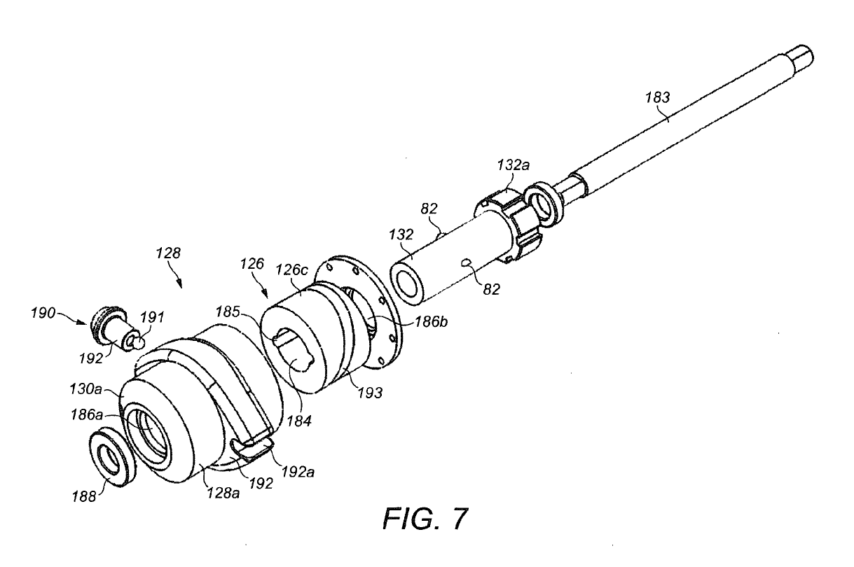

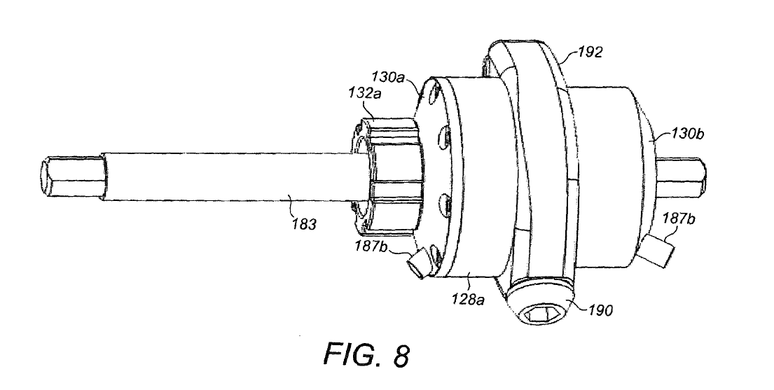

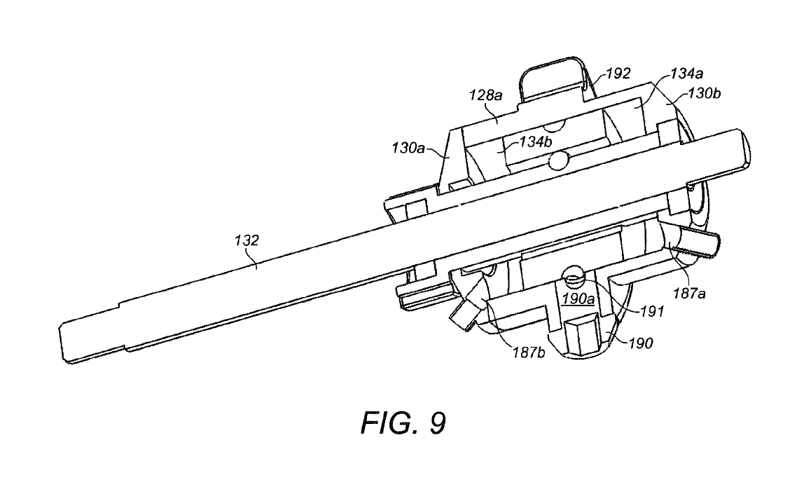

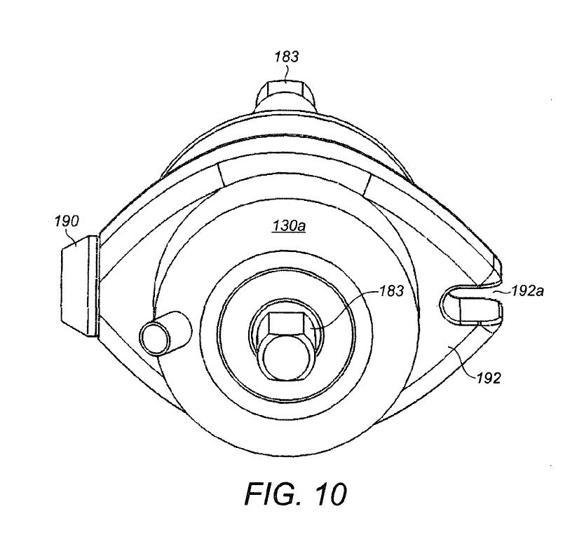

Referring to FIGS. 7 to 10, a hydraulic motor 112 accordingly to an embodiment, for the hydraulic transmission system comprising the pump 110 described above, is configured for mounting at the rear of a bicycle to drive rotary motion of the rear wheel. The motor 112 includes a piston 126, a second drive shaft 132 and a second cylinder 128.

The second drive shaft 132 has a passage of circular cross-section extending axially therethrough. The second drive shaft 132 also has an end portion 132a configured to engage with a corresponding configured hub (not shown) of a rear bicycle wheel. The end portion 132a engages with the hub so that rotational motion of the second shaft 132 causes corresponding angular movement of the hub and thus the bicycle wheel. The engagement of the end portion 132a and the hub is achieved by the end portion having a splined surface and the hub having a recess therein having a matching surface. In variant embodiments, the second shaft 132 may include a conventional free-wheel mechanism (not shown).

The majority of rear hubs in use are configured to secure to a cassette. Hubs and cassettes are typically shaped in accordance with one of a number of standards. Preferably, the end portion 132a is shaped to engage with such a hub in place of a cassette.

The hub when engaged with the second drive shaft 132 is mountable on a skewer 183 which extends through the axial passage. The skewer 183 may be to a conventional design, and is itself mountable in dropouts in regions of a bicycle where the seat stay and the chain stay join. The skewer 183 permits free rotation of the second drive shaft 132 on it.

The second piston 126 is substantially cylindrical, has a passage 184 extending axially therethough and is mounted on the second drive shaft 132 so that rotational motion of the second piston 126 about its central axis causes corresponding rotational movement of the second drive shaft 132 and relative reciprocating longitudinal sliding movement is permitted. This may be achieved in the same manner as the engagement between the first drive shaft 124 and the first piston 116 in the pump 110 described above, that is, with matching male and female spline parts indicated at 182 and 185 in FIG. 7.

The second cylinder 128 comprises a cylinder body 128a and first and second closures 130a, 130b, like the pump 110.

The cylinder body 128a has a cylindrical inner surface defining a cylindrical space having a substantially circular cross-section. The cylindrical space is closed by the first and second closures 130a, 130b being fixedly attached to a first annular end face of the cylindrical body 128a. The first closure 130a is integrally formed with the cylinder body 128a.

Each of the first and second closures 130a, 130b has a respective central hole 186a, 186b therethrough. The second drive shaft 132 extends through the passage 184 in the second piston 126 and the holes 186a, 186b in the first and second closures 130a, 130b and then ends at the end portion 132a. The other end of the second drive shaft 132 abuts against an annular bearing assembly 188, the bearing assembly being attached to the second closure 130a, permitting rotation of the second drive shaft 132, preventing lateral movement of the second drive shaft 132, and preventing egress of fluid.

The cylinder body 128a, the first and second closures 130a, 130b and the first and second ends of the second piston 126 define first and second fluid chambers 134a, 134b. The fluid transmission system is sealingly connected to the first and second chambers through a pair of apertures 187a, 187b leading to each of these chambers 134a, 134b. By means of these apertures, the first line 138a is sealingly connected to the first chamber 134a and second line 138b is sealingly connected to the second chamber 134b to provide fluid alternately to each one of these chambers, thereby to drive the piston 126 back and forth.

A first hole extends from the cylindrical space in the cylinder 128 to the exterior. A bearing mount 190, like the bearing mount 170a described as part of the pump 110, comprises a projecting portion 190a that retains a ball bearing 191 in the cylinder body so that the ball bearing 191 projects from the cylindrical inner surface.

The projecting portion 190a has a threaded circumferential surface, which engages in a correspondingly threaded surface in the cylinder body 128c.

Like the first piston 116 in the pump 110, the second piston 126 has an outer cylindrical surface 126c including a linking portion in the form of a continuous non-linear groove 193 extending continuously around the cylindrical surface 126c in a wave-like manner. When the second piston 126 is located in the cylindrical body 191, the ball bearing 191 extends into the non-linear groove 193.

The cylinder 128 is coupled to the bicycle frame so that relative movement of the cylinder 128 and the frame is prevented. To this end, a lobe 192, fixedly attached to the exterior of the cylinder 128 has a part-cylindrical recess 192a therein alignable with a dropout (not shown) provided on a bicycle frame, usually for attachment of a rear derailleur. A bolt (not shown) fits through the recess to fixedly secure to the drop out by means of screw engagement. In particular, fixed coupling of the cylinder 128 relative to the frame prevents axial rotation of the second cylinder 128, which means that force imparted by the surface of the groove 193 on the ball bearing 191 cannot result in the cylinder 128 rotating.

The first and second transmission lines 138a, 138b extend in or along one or both chain stays to the hub. In an embodiment, these transmission lines are integrally formed with the or each chain stay.

Operation of a transmission system comprising the pump 110 and the motor 112 will now be described. A rider of a bicycle pedals so that the first shaft 124 is rotated, which causes the first piston 116 to rotate. As the first piston 116 rotates, the portion of the non-linear groove 178 in contact with the ball bearing 174a, 174b instantaneously changes, and, due to the longitudinal variation in the location of the portion, the ball bearing force the piston 116 to reciprocate. The reciprocating movement of the first piston 116 causes fluid to flow alternately out of one of the first and second chambers 122a, 122b as the volume in that chamber is decreased and the pressure increased, and to be sucked into the other of the chambers 122a, 122b as the pressure therein is decreased. The way in which this occurs is as described above in relation to the operation of the hydraulic transmission system described with reference to FIG. 1A.

Thus reciprocating movement of the first piston 116 results in repetitive reciprocating movement of the second piston 126 in the second cylinder 128. As the second piston 126 moves back and forth, the ball bearings 191 bear against surface of the groove 193. The ball bearing 191 forces the second piston 126 to rotate in order to reciprocate. Rotation of the second piston 126 causes corresponding rotational motion of the second drive shaft 132, which drives rotation of the attached hub and wheel about the skewer 183.

In alternative embodiments, the motor 112 may be located and configured to drive the front wheel. It is clear to the person skilled in the art how the motor 112 may be modified to achieve this. In alternative embodiments, operation of the pump 110 may drive a pair of motors, one for driving rotation of the front wheel and the other for driving rotation of the rear wheel. The fluid regulation system is modified for this.

In another specific embodiment, a pump 210 of a hydraulic drive transmission system is implemented as part of a motorcycle. In particular, the transmission system may be implemented as part of a scooter, which is typically a motorcycle with a step-through frame and a platform for a rider's feet. The system includes the fluid transmission system as described generally above with reference to FIG. 1B.

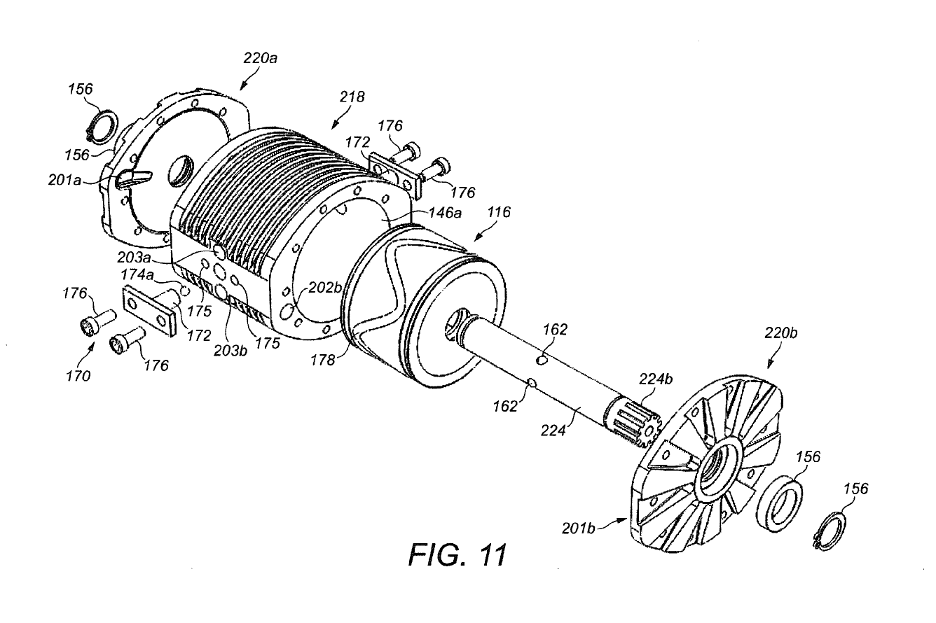

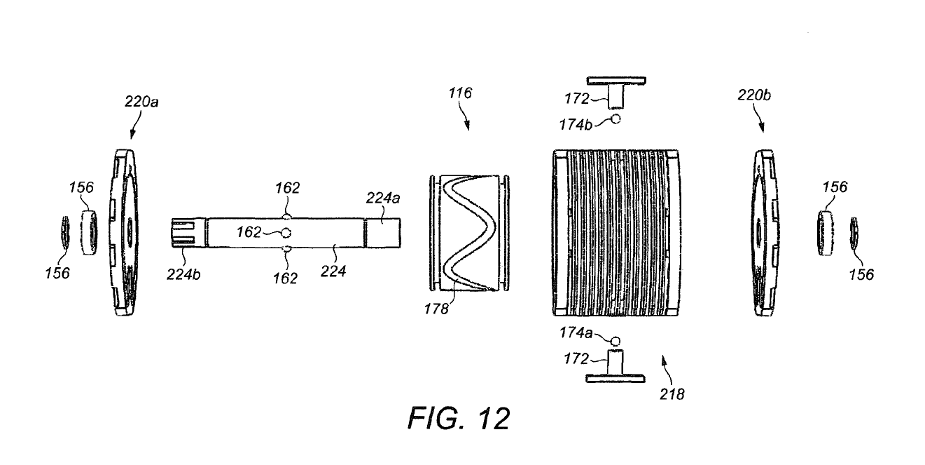

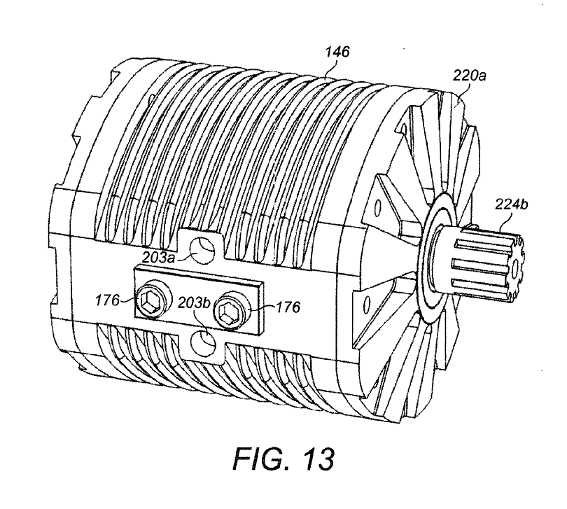

Referring to FIGS. 11 to 13, the pump 210 is structurally and operatively similar to the pump 110 for a bicycle. One difference is that the first drive shaft 224 is rotatably driven by an electric motor (not shown) or a combustion engine rather than by operation of pedals. An end 224a of the first drive shaft 224 is configured for engagement with such a motor or engine. Also, outer surfaces of the cylindrical body 246 and the first and second closures 220a, 220b are shown corrugated for improved heat dispersion and aesthetics.

Another difference is that apertures forming inlets and outlets to the first and second fluid chambers do not extend to nozzles 191a, 191b like in the pump 110. Instead, the cylinder body 246 has first and second passages therethrough. The first passage extends from a first opening to the first chamber 222a at a first end thereof to a second opening 203a in the vicinity of the bearing mount. The second passage extends from a first opening 202b to the second chamber 222b at a first end thereof to a second opening 203b in the vicinity of the bearing mount 170. Each passage is formed in the material of the cylinder body 246. The first opening 202a, 202b of each passage is located in a respective annular face of the cylinder body 246. As with the pump 110 described above, first and second closures 220a, 220b are respectively sealingly attached to the annular end faces of the cylinder body 246 to in part define the first and second fluid chambers. However, in the present embodiment the first and second passages are sealingly connected for fluid communication with the respective first and second chamber 234a, 234b by virtue of a recess 201a in the corresponding inner surface of each closure 220a, 220b. A part of each recess 201a, 201b overlies the first opening and the recess 201a, 201b is also open to the chamber.

It will be appreciated that the pump 210 need not be disposed in a scooter in the same way as the pump 110 is disposed in a bicycle, that is, the first drive shaft 224 need not extend perpendicularly from the general plane of the scooter.

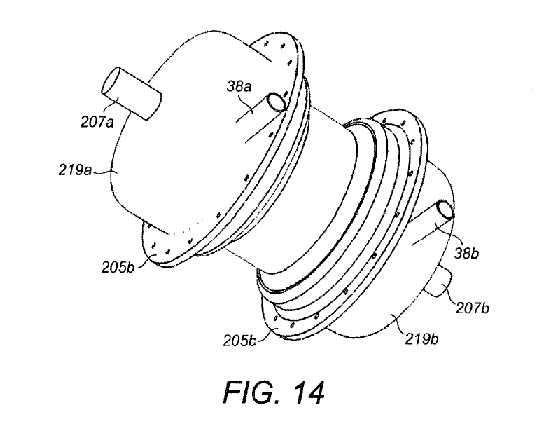

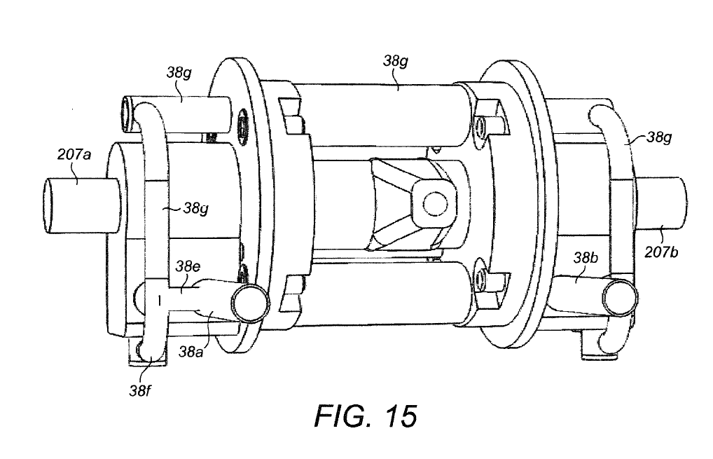

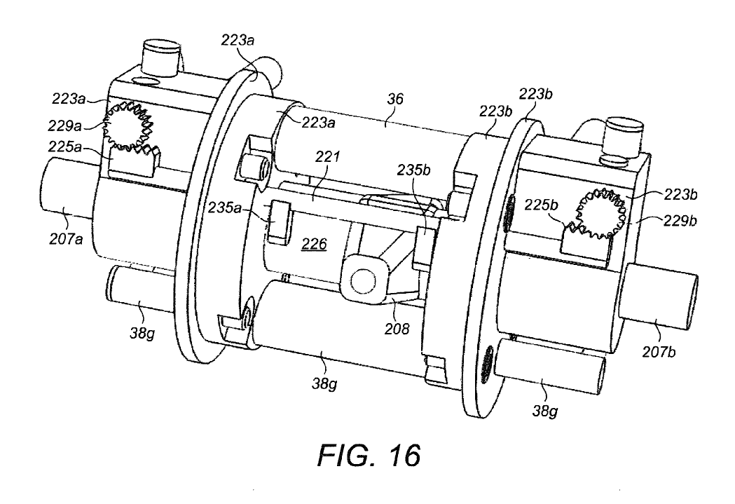

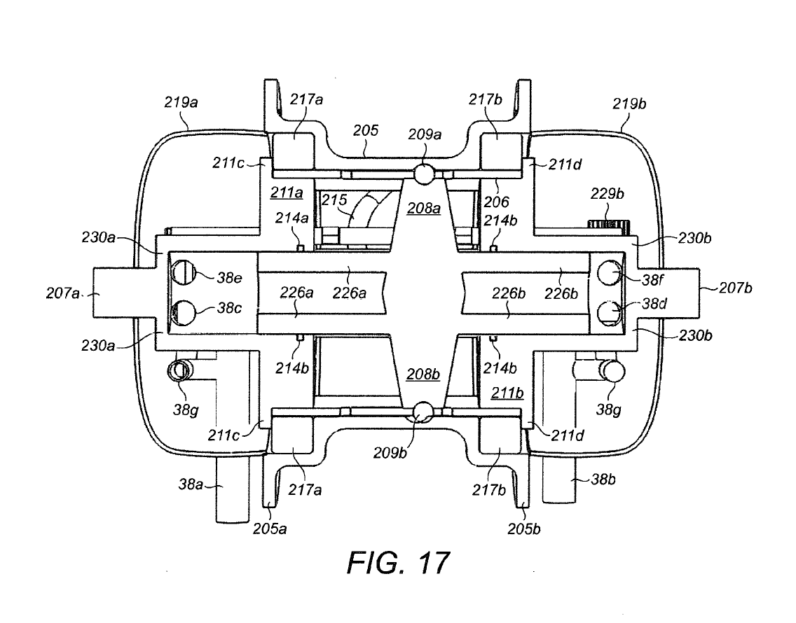

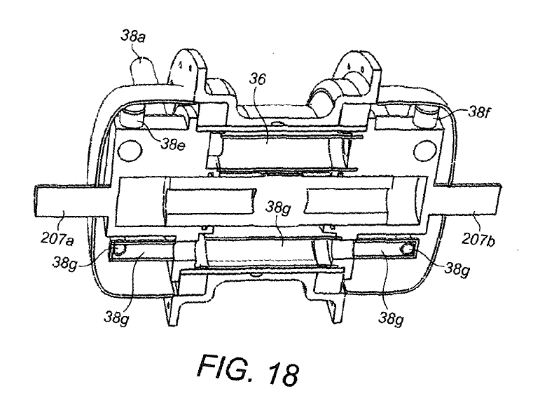

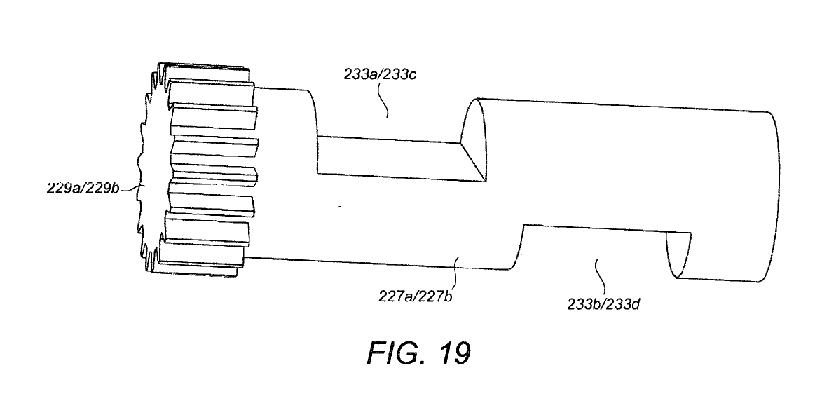

Referring to FIGS. 14 to 19, in another embodiment, a motor 212 for the hydraulic transmission system comprising the pump 210 is for use in a motorcycle and operates using similar principles to the motor 112 for the bicycle, but is structurally different. The motor 212 comprises a piston 226, a first cylinder portion 204a, a second cylinder portion 204b, a sleeve means in the form of a rotatable cylindrical drive member 205, and a cylindrical support sleeve 206.

The motor 212 forms part of a hub of a wheel and is for mounting on the frame of a motorcycle. The motor 212 has first and second spaced axle portions 207a, 207b disposed on the same axis, that fixedly engage in suitably disposed recesses in the frame.

Each of the first and second cylinder portions 204a, 204b is closed at one end thereof respectively by first and second closures 230a, 230b. The first and second cylinder portions 204a, 204b are respectively configured to sealingly receive first and second ends 226a, 226b of the second piston 226. To enable the second piston 226 to reciprocate, the first and second cylinder portions 204a, 204b are aligned so that open ends thereof respectively face. The second piston 226 has a central axis, which is aligned with the axis of the first and second axle portions 207a, 207b. The first and second axle portions 207a, 207b are fixedly attached to the first and second cylinder portions 204a, 204b so that said axle portions 207a, 207b respectively extend from the outer surface of the first and second closures 230a, 230b. Although not essential, the first and second axle portions 207a, 207b and the first and second cylinder portions 204a, 204b are respectively integrally formed.

The second piston 226 is moveable back and forth into and out of the first and second cylinder portions 204a, 204b to exert alternately a compressive force on fluid in a first chamber 234a defined between a first end 226a of the second piston 226 and the first closure 230a, and a second chamber 234b defined between a second end 226b of the second piston 226 and the second closure 230b. The second piston ends 226a, 226b each has a circular outer cross-section, which fits in a sealing manner into correspondingly shaped interiors of the cylinder portions 204a, 204b. First and second O-rings 214a, 214b are located in annular circumferentially extending recesses in the cylinder portions 204a, 204b to prevent egress of fluid from the first and second fluid chambers 234a, 234b between the interior surface of the respective cylinder portion and the respective piston end. In other embodiments, the cross-sections of the piston ends 226a, 226b are not circular.

The motor 212 includes a pair of lobes 208a, 208b extending radially from the piston body. Each lobe retains a bearing 209a, 209b at an end thereof. The support sleeve 206 is mounted on circumferential surfaces of first and second flanges 211a, 211b extending radially outwardly from the open ends of the cylinder portions 204a, 204b. The support sleeve 206 includes a pair of elongate slots 213a, 213b extending parallel to the axis of the support sleeve 206, through each of which one of the ball bearings 291a, 291b partially projects. The slots 213a, 213b restrict movement of the respective ball bearing 291a, 291b to movement in the slot 213a, 213b parallel to the axis of the second piston 226. The slots may also serve to retain the ball bearings in position.

The cylindrical drive member 205 has circular cross-section, a central axis that is coaxial with the axis of the first and second axle portions 207a, 207b, and extends around the support sleeve 206. First and second respectively spaced annular bearing assemblies 217a, 217b coaxial with the axis of the piston 226 are located between the drive member 205 and the support sleeve 206 with the slots 213a, 213b extending between them. These bearing assemblies 217a, 217b are spaced to allow movement of the bearings 291a, 291b in the slots 213a, 213b, and bear against lips 211c, 211d extending radially from the first and second flanges 211a, 211b. The bearing assemblies 217a, 217b prevent axial or lateral movement of the drive member 205, but permit rotational movement of the drive member 205 in a low friction manner.

The drive member 205 also includes a pair of spaced, annular, radially extending flanges 205a, 205b to which spokes may be attached. Motorcycle wheels often do not include spokes; the drive member 205 may in alternatives be otherwise coupled to the wheel rim.

The interior surface of the drive member 205 has a non-linear groove 215 therein extending continuously around the inner circumference of the drive member 205 in a wave-like manner. The first and second ball bearings 291a, 291b each project through the respective slot and extend into the non-linear groove 215. Reciprocating movement of the ball bearings 291, 291b in the slots 213a, 213b requires rotation of the drive member 205.

A protective casing 219a, 219b covers the cylinder portions 204a, 204b of the motor 212.

The motor 212 is attached to second ends of the first and second transmission lines 38a, 38b shown schematically in FIG. 1B, but otherwise incorporates the other parts of fluid transmission system and the control mechanism therefor.

The control mechanism, described generally above with reference to FIG. 1B, comprises a bar 221 and first and second control blocks 223a, 223b. The bar 221 extends lengthwise through apertures in the first and second annular support flanges 223a, 223b and has a first rack 225b at one end and a second rack 225b at the other end.

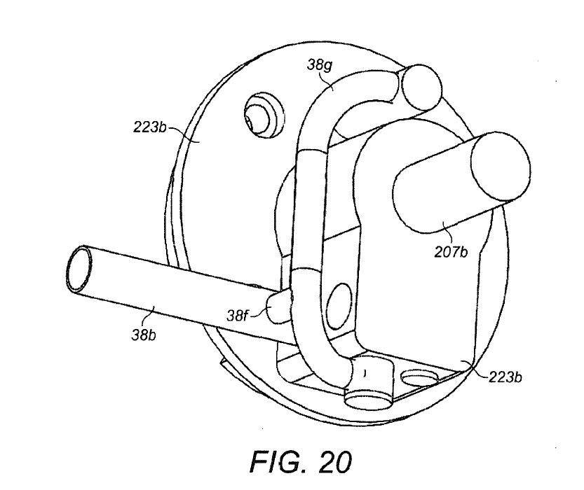

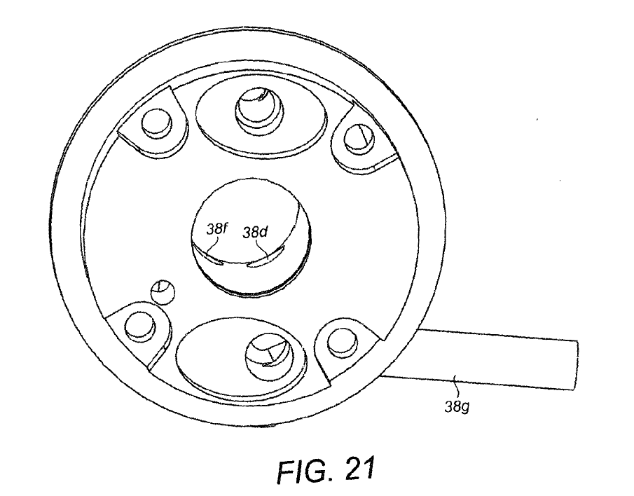

The first and second control blocks 223a, 223b respectively comprise a first and second gate member 227a, 227b, as best seen in FIG. 20, each gate member being rotatably coupled to a respective one of first and second pinions 229a, 229b. Each of the first and second pinions 229a, 229b is coupled to a corresponding one of the first and second racks 225a, 225b. Linear movement of the first and second racks 225a, 225b thus causes angular movement of the first and second pinion 229a, 229b. The first and second gates members 227a, 227b are in the form of an axially rotatable spindle, on an end of which a corresponding one of the first and second pinions 229a, 229b is mounted, and first and second radially extending and angularly offset first, second, third and fourth recesses 233a-d in the spindle.

Sliding movement of the bar 221 causes the control mechanism to change between the first and second states. In the first state, the first rack 225a is located such that the first pinion 229a and thus the first gate member 277a are angularly disposed so that the gate member 227a blocks fluid flow in the fifth transmission line 38e and permits fluid flow in the third transmission line 38c through the second recess 38e. In this state, the second pinion 229b and thus the second gate member 227a are angularly disposed so that the second gate member 227a blocks fluid flow in the fourth transmission line 38d and permits flow in the sixth transmission line through the third recess 233c.

When the control mechanism is in the second state, the first pinion 229a and thus the first gate member 227a are angularly disposed so that the first gate member 227a permits flow in the third transmission line 38c and via the first recess 233a blocks fluid flow in the transmission line. In this state, the second pinion 229b and thus the second spindle 231a are angularly disposed so that the third projection 233c blocks fluid flow in the transmission line and the fourth projection permits fluid flow in the transmission line.

The control mechanism is changed between the first state and the second state by sliding movement of the bar 221, which moves the first and second racks 225a, 225b. First and second push parts 235a, 235b are fixedly attached to the bar 221, are relatively spaced, and are each disposed in the path of reciprocating movement of the second lobe 208d. On movement of the second piston 226 alternately into the first and second fluid chambers, the second lobe 208b pushes, respectively, the first and second push parts 235a, 235b, thereby sliding the bar 221.

In operation, the pump 210 works in the same way as the pump 110 described above. Rotation of the drive shaft 224 by an electric motor or combustion engine causes pressure in the pressurised fluid reservoir 36.

The pressure in the pressurised fluid reservoir 224 drives the motor 210. Fluid is supplied alternately to the first and second chambers so that the second piston 226 reciprocates in accordance with description of operation of the hydraulic transmission system described with reference to FIG. 1B. Operation of the control mechanism is now described in detail. Where the second piston 226 is initially at rest, the pressurised fluid reservoir 36 and the control mechanism is in the second state, fluid flows into the first cylinder portion 204a, thereby increasing the size of the first fluid chamber and moving the second piston 226 into the second cylinder portion 204b. At a predetermined point of movement, the second lobe 208b abuts the second push part 235b and pushes the push part. As the push part 235b moves, the bar 221 slides correspondingly, resulting in each of the first and second racks 225a, 225b causing angular movement of the corresponding one of the first and second pinions 225a, 225b. After the second lobe 208b has pushed the push part 235b to such an extent that the control mechanism is in the first state, the second piston 226 is moved in the reverse direction, that is, into the first cylinder portion 204a.

Then, in the same way, at another predetermined point of movement, the second lobe 208b abuts the first push part 235a and pushes the first push part 235a. As the first push part 235a moves, the bar 221 slides correspondingly, resulting in each of the first and second racks 225a, 225b causing opposite angular movement of the corresponding on of the first and second pinions 2259, 229b. After the first lobe 208a has pushed the push part 235a to such an extent that the control mechanism is in the first state, the second piston 226 changes direction of movement again. The reciprocating movement of the second piston 226 and the changing between states continues as long as there is pressure in the pressurised fluid reservoir 36.

Such reciprocating movement causes corresponding reciprocating movement of the bearings 209a, 209b in their respective slots. The bearings 209a, 209b impart force to the surface of the non-linear groove, causing the drive member to rotate around the support sleeve 206. Since the axis of the support sleeve 206 and the second piston 226 are the same, the drive member also rotates around the second piston 226 and also about the axis of the first and second axle portions 207a, 207b.

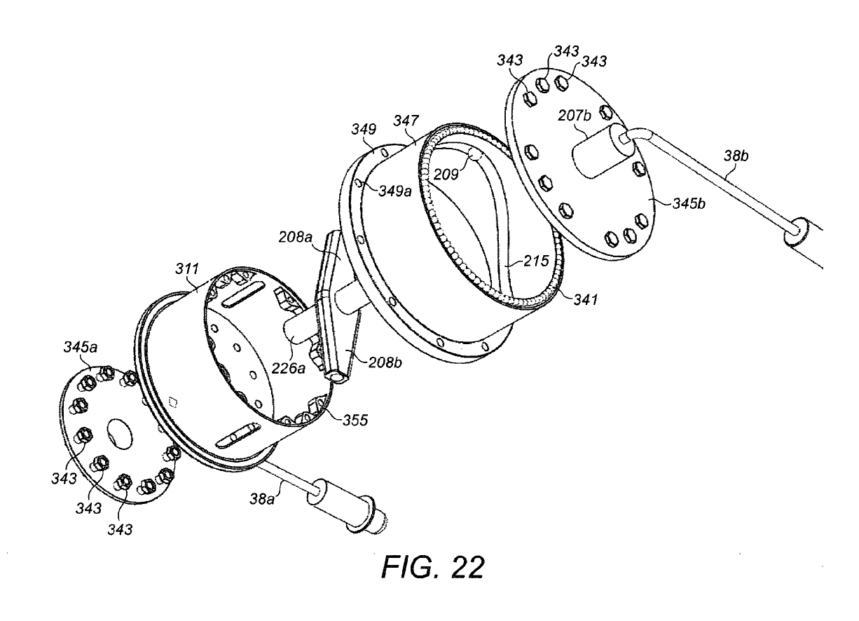

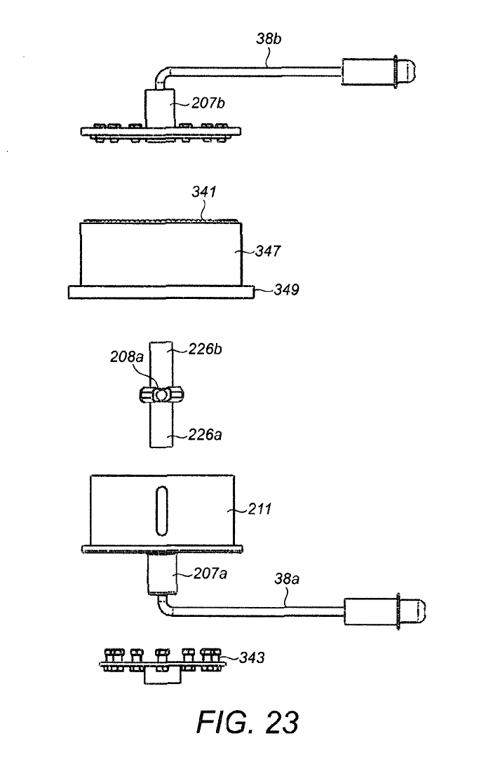

In another embodiment now described with reference to FIGS. 22 to 24, a motor 312 for a hydraulic transmission system is provided that is intended for use with heavy equipment. The motor 310 is a variant on the motor 210 described above in relation to use in a motorcycle. A pump having the same features and operating in the same manner may be used as already described, as may the fluid transmission system.

Like the motor 212, the motor 312 includes first and second lobes 208a, 208b, a cylindrical support sleeve 311 having elongate slots, which is functionally like support sleeve of the motor for the motorcycle, the piston 226, a non-linear groove 215 in an inner cylindrical surface of a drive member 347, which is functionally like drive member 205, and the first and second cylinder portions 207a, 207b.

A flange 349 extends circumferentially around the drive 347. The flange 349 has a plurality of apertures 349a therethough enabling bolting to a coaxially positioned wheel, to drive coaxial rotational movement.

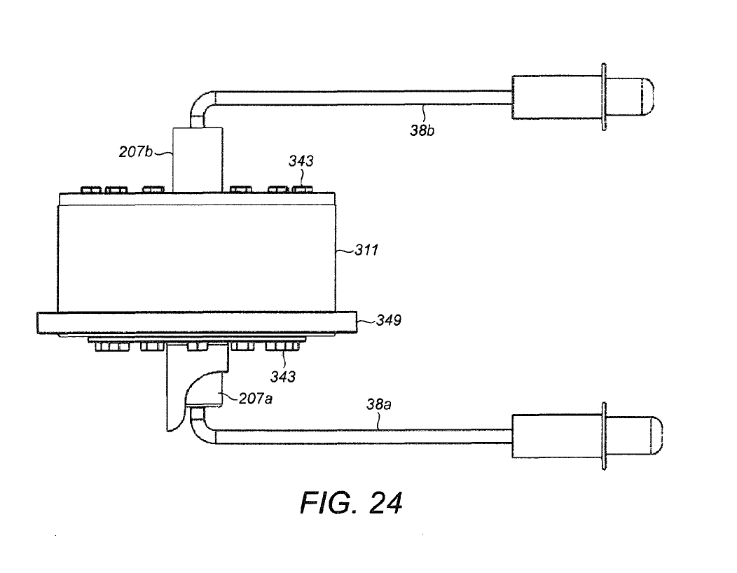

As can be seen, a fluid transmission line 38a, 38b is sealingly attached to each of the first and second cylinder portions 207a, 207b for supply of fluid to the fluid chambers and receipt of fluid from the chambers, in the appropriate alternating manner to cause reciprocating motion of the piston 226. As can be seen in FIG. 24, the second end plate is fixedly coupled to the chassis of the heavy equipment to prevent relative movement, thereby preventing rotational movement of the support sleeve 311, with the plate. In another embodiment, the first and second transmission lines 38a, 38b extend on one side of the motor 312 for ease of attachment to a vehicle. For example, the line 38b may extend around the motor 312.

The motor 312 is coupled to a fluid pump, which is typically operable by means of an electric motor or combustion engine, via the transmission lines 38a, 38b in the same way as the motor 112 for the bicycle, as described above in relation to this motor 112 and the FIG. 1A. Operation of the motor 312 is carried out in the same way as in this case. It will be appreciated that each of the fluid chambers of the motor 312 may be operatively connected to a pressure generation and transmission system utilizing fluid as described with reference to FIG. 1B.

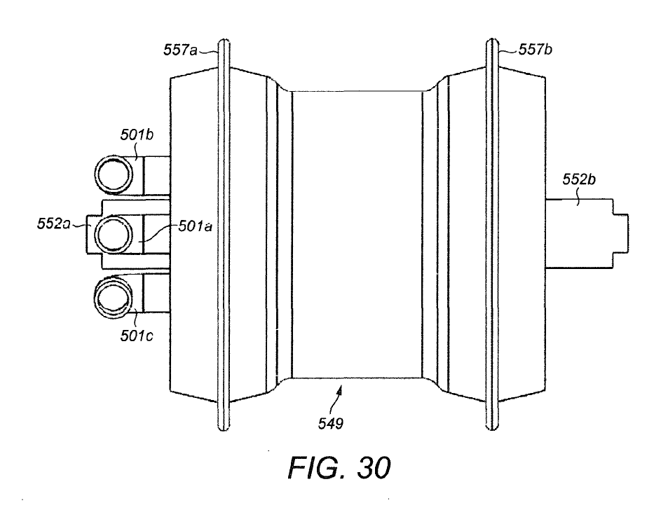

Another embodiment of a hydraulic transmission system will now be described that includes a hydraulic pump 410 and a hydraulic motor 512. The hydraulic pump is described with reference to with reference to FIGS. 25 to 29 and the motor 512 with reference to FIGS. 30 to 34. Unlike in previous embodiments, the pump and motor in this embodiment do not include a double-ended piston. Instead, there are multiple pistons that act on fluid in a corresponding number of fluid chambers in the pump and a corresponding number of cylinders in the motor in which fluid is pushed. Each fluid chamber in the pump is in fluid communication with a corresponding one fluid chamber in the motor via a respective single fluid transmission line.

As with previous embodiments, it should be understood that the motor 512 can be used with a different design of pump, and the pump may be used with a different design of motor. In other words, the particular pump described is not essential to the motor and vice versa.

Motion conversion arrangements described in relation to the motor 512 and the pump 610, including a groove and a projection, may be varied as described in relation to other embodiments.

The system is intended for use in a bicycle, although it will be understood that its application and the application of variants is not limited to use in bicycles. The pump 410 includes piston-cylinder assemblies comprising first, second and third reciprocating-type pistons 401a-c respectively associated with first, second and third cylinders 403a-c. Each of the first, second and third cylinders 403a-c comprises a tubular body carried by a disc 405 on which the first, second and third cylinders 403a-c are mounted. The bodies of the first, second and third cylinders 403a-c are integrally formed with the disc 405, although in variant embodiments they may be formed separately and mounted using bolts or other conventional techniques.

At least a portion of each of the bodies of the first, second and third cylinders 403a-c has a substantially square cross-section, thus having four side walls, some of which are shown at 407a, 409a-c, 411a-c, 413a-c. Edges of the four side walls of each of the first, second and third cylinders 403a-c form an opening to the respective body at one end. A first 407a of the side walls is integrally formed with the disc 405. The first side wall 407a and a second of the side walls 409a-c opposing the first side wall 407a each have a linear slot 421a-c, 423a-c extending from the edge at the opening into the respective side wall.

Each of the first, second and third pistons 401a-c comprises a piston body 425a-c, a piston head 427a-c at one end of the piston body, and a roller pin 429a-c at the other end of the piston body. The roller pin 429a-c has ends extending laterally of the piston body. Each of the first, second and third pistons 401a-c is configured to engage in the corresponding cylinder 403a-c, with the roller pins 429a-c engaging in the respective slots 421a-c, 423a-c and each piston body 425a-c and piston head 427a-c is shaped for reciprocating movement in the corresponding cylinder 403a-c.

Each cylinder 403a-c and associated piston head 427a-c defines a fluid chamber. Each of the piston bodies 425a-c has a circumferentially extending groove therein in which a lip seal 429a-c is located to prevent egress of fluid from the respective fluid chamber. An aperture is located in each cylinder body at the end of the cylinder body remote from the piston head 427a-c. A transmission line 431b, 431c is sealingly attached to each aperture to enable inflow and outflow of fluid. An arcuate flange 433 extends from the periphery of the disc 405 adjacent the first cylinder 403a, of which an end of the body of the first cylinder 403a is part. The aperture located in the cylinder body of the first cylinder 403a extends though the flange 433 and is indicated at 435a. Although not shown, a further transmission line is in practice attached to the aperture 435a to enable flow of fluid into and out of the chamber of the first cylinder 403a. The transmission lines 431b, 431c extending from the second and third cylinders 403b, 403c each extend through a respective hole in the flange 433, resulting in tidy arrangement of the transmission lines.

Each cylinder 403a-c is located on the disc 405 so that the respective slots 421a-c, 423a-c extend radially with respect to an axis of a drive shaft, which is described below. Both a third one of the side walls 411a-c and a fourth one of the side walls 413a-c which faces the third side wall 411a-c each have recesses 435a-c therein extending inwardly from an outer edge of the respective wall.

A mechanism for driving reciprocating movement of the pistons 401a-c in the cylinder 403a-c is now described. The disc 405 has a shaft aperture 437 therethrough through which a drive shaft 439 extends. The drive shaft 439 carries an cam disc 441, which is mounted to extend radially on the drive shaft 439. The cam disc 441 is in the approximate shape of a parallelogram with rounded edges. The cam disc 441 is mounted on the drive shaft 439 and abuts against the roller pin 429a-c of each piston 401a-c during each rotation of the cam disc 441, thereby to depress each piston 401a-c twice each time the cam disc 441 rotates.

The shape of the cam disc 441 is preferably but not essentially such that the edge of the cam disc 441 maintains contact at all times with each roller pin 429a-c, or at least for the majority of the time, for low vibration. While the cam disc 441 is approximately parallelogram shaped in the present embodiment, other shapes of cam disc may be used in variant embodiments, for example an oval shape, an eccentric circular cam or a pear shaped cam. The selection of the shape of the cam may depend on the configuration of the hydraulic motor to which the pump is attached. More than one cam may be mounted to push the pistons.

A drive shaft sleeve 443 extends from the periphery of the aperture 437 in the disc 405. The drive shaft 439 extends through the drive shaft sleeve 443. First and second bearing assemblies 445a, b are located between the drive shaft 439 and the drive shaft sleeve 443 to allow free rotational movement of the drive shaft 439 in the sleeve 443, while preventing lateral movement. A spacing element 447 is located between the drive shaft sleeve 443 and the drive shaft 439 to maintain the desired distance between the bearing assemblies 445a, b.

First and second grooves 449a,b extend circumferentially around the drive shaft 439. The first groove 449a is located adjacent the cam disc 441 between a first end 439a of the drive shaft 439 and the cam disc 441. The second groove 449b is located against the second bearing assembly 445b. First and second circlips 451a,b are respectively located in the first and second grooves 449a,b.

As mentioned above, the pump is intended for use in a hydraulic transmission system of a bicycle. The drive shaft 439, in use, extends through a bottom bracket shell (not shown) of a bicycle. Both the first and second ends 439a,b extend beyond the shell; the first end 439a of the drive shaft 433 extends beyond the cam disc 433. Both ends have a square cross-section to permit mounting of crank arms. Configuration of parts for attachment of crank arms is well known in the art.

A threaded nut 453 is attached to an end of a near end 443a of the drive shaft sleeve 443 so that, when the pump is mounted in a bottom bracket shell, it does not dislodge.

In use, rotation of the crank arms drives rotation of the drive shaft 439. Rotation of the drive shaft 439 causes rotation of the cam disc. Rotation of the cam disc causes, consecutively, each of the first, second and third pistons 401a-c to push fluid from the fluid chamber in the corresponding cylinder 403a-c, thereby to push fluid in the corresponding one of the transmission lines 431b,c.

A fluid motor 512 is now described with reference to FIGS. 30 to 34, for use with the pump 410. The first, second and third transmission lines from the first, second and third cylinders 403a-c extend from the pump 410 to sealing attach to first, second and third connector pieces 501a-c at the fluid motor 512. The fluid motor 512 comprises first and second end pieces. The first end piece comprises an end disc 503a and first, second and third cylinders, all integrally formed of a single piece of material.

The end disc 503a has first, second and third cylindrical apertures 505a-c therethrough into which the first, second and third connector pieces 501a-c are engaged. The first, second and third cylinders 507a-c extend perpendicularly from the disc 503a around the periphery of each of the cylindrical apertures 505a-c. The interior of the first, second and third cylinders 507a-c and the first, second and third transmission lines are in fluid communication so that fluid can flow into and out of each of the first, second and third cylinders 507a-c respectively from the first, second and third transmission lines via the first, second and third connector elements 501a-c. First, second and third pistons 509a-c are arranged to move in the corresponding cylinder 507a-c.

Each of the first, second and third cylindrical apertures 505a-c has a circumferential groove extending around the respective interior surface thereof. A base of each of the first, second and third connector pieces 501a-c are shaped to closely fit in the corresponding cylindrical aperture 505a-c and to engage therein by means of a circlip located in each groove. The disc 503a also has three holes 521a-c therethrough each arranged to receive a tapered head bolt 523a-c.

The second end piece also includes an end disc 503b having three holes therethrough each arranged to receive a tapered head bolt 529a-c.

The fluid motor 512 further comprises a rigid frame 511 comprising a pair of annular end pieces 513a,b joined by first, second and third bridge member 515a-c. The frame 511 could otherwise be formed as a cylindrical tube, but has been formed as described to reduce weight. Each bridge member has a slot therein 517a-c. Each of the first and second annular end pieces 513a,b has integrally formed therewith three inwardly-extending threaded socket pieces 519a-c 535a-c, each spaced to align with the holes 521a-c in the disc 503a. The frame 511 is thus attached to the end disc 503a of the first end piece by the tapered head bolts 523a-c, which extend through the holes 521a-c into the socket pieces 519a-c, attaching thereto by screw engagement. Similarly, the frame 511 is attached to the end disc 503b of second end piece by the tapered head bolts 529a-c, which extend through the holes in that end disc and into the socket pieces 535a-c, attaching therein by screw engagement.

The fluid motor 512 further comprises a rigid drive sleeve 525. The sleeve 525 comprises a first ends piece 527a, a second end piece 527b and a middle piece 527c joined by bridging pieces 531a,b. Like the frame 511, the drive sleeve 525 could be in substantially cylindrical form, but the form of the present embodiment is preferred to reduce weight. The drive sleeve 525 fits over the frame 511 and is coaxial therewith. The drive sleeve 525 has a stepped end having a slightly larger diameter than the rest of the drive sleeve 525 so as to accommodate needle bearing 545a, 545b. These are located between the drive sleeve 525 and the frame 511 to permit free relative rotation of the drive sleeve 525 and the frame 511. The middle piece 527b has a continuous groove 533 extending circumferentially around the interior surface thereof. The groove extends laterally as well as circumferentially in the interior surface.

Each of the first and second end pieces has three holes therein, pairs of which are respectively aligned. Two of the holes in the second end piece can be seen at 537a,b. Three rails 539a-c extend between pairs of holes 537a,b. Each rail has an associated arm 541a-c having an aperture therethough at one end through which the rail 539a-c extends. Each arm 541a-c can thus be moved back and forth on the associated rail. Each arm 541a-c is arranged to carry a bearing 543a-c at the other end thereof. Each arm 541a-c extends from the associated rail to a respective one of the slots 517a-c in the frame 511. Each bearing extends through the slot 517a-c to engage into the groove 533 in the drive sleeve 525. The groove 533 and the bearings are arranged so that back and forth movement of the arm in the corresponding slot 517a-c causes rotation of the drive sleeve 525 around the frame 511. The slots 517a-c serve to prevent rotational movement of the arms relative to the frame 511.

The first, second and third pistons 509a-c are respectively located in the first, second and third cylinders 507a-c and can move back and forth therein, subject to forces applied by the fluid. The first, second and third pistons 509a-c are each arranged, like with other pistons described herein, to define respective fluid chambers in the corresponding cylinder and also to prevent egress of fluid from the fluid chambers, for example using seals. Flow of fluid into a fluid chamber pushes the corresponding piston out of the corresponding cylinder and flow of fluid into the fluid chamber draws the corresponding piston into the corresponding cylinder. Each of the first, second and third pistons 509a-c has attached thereto a connector pin 547a-c connecting the piston to a corresponding one of the arms 541a-c. Each connector pin 547a-c connects the corresponding piston to the corresponding arm so that back and forth movement of the piston causes back and forth movement of the arm on the respective rail 539a-c.

Back and forth movement of each arm causes back and forth movement of the bearing 541a-c carried by that arm in the slot 517a-c, which causes rotation of the drive sleeve 525.

Rotation of the fluid motor 512 is intended to result in rotation of a bicycle wheel. To this end, an outer drive shell 549 is located on the drive sleeve 525 coaxially therewith, so that the assembled components form a hub.

The hub is configured so that the outer drive shell 549 can rotate freely around the drive member 525 when no power is applied. A freewheel mechanism is provided for this. The freewheel mechanism includes first and second further needle bearing 551a, located between the drive sleeve 525 and the outer drive shell 549 to permit low friction movement.

An annular saw-toothed ratchet 553 is fixedly attached to the drive sleeve 525. The outer drive shell 549 has an interior surface including a plurality of spaced recesses 555 to accommodate movement of a latch (not shown) attached to the shell 549. Freewheel mechanisms and free hubs are well known in the art and details of how a freewheel mechanism can be achieved will be clear to the skilled person.

The outer drive shell 549 has a pair of spaced radially extending flanges 557a,b configured for attachment of bicycle spokes (not shown), the spokes being in turn attached to a rim (not shown).

First and second annular spacers 559a, b are also provided and sized to prevent lateral movement of the component parts of the hub assembly.

On operation of the fluid pump 510 described with reference to FIGS. 25 to 29, fluid is provided consecutively to the fluid chambers in the first, second and third cylinders 507a-c in a regular manner. After fluid has been forced into a particular chamber to the maximum extent resulting from the configuration of the hydraulic system, the fluid is allowed to exit the fluid chamber.

Forcing of fluid into a fluid chamber causes the corresponding piston 509a-c to move. The result is that the arms 541a-c are moved back and forth in a reciprocating manner each on its respective rail 539a-c. Reciprocating movement of the arms and thus of the bearings 541a-c in the groove 533 forces the drive sleeve 525 to rotate on the frame 511 about a central axis. On rotation of the drive sleeve, the free wheel mechanism provides a drive force to the outer drive shell 549, thereby to drive the wheel.

As will be appreciated, there may be greater or fewer than three piston/cylinder assemblies on the pump 410 and fluid motor 512.

The pump 410 and motor 512 described above were in part developed to address an issue with some of the other embodiments described herein, which is that a wheel attached to some designs of motor would rotate turn one way and then the other, rather than exclusively in one direction. Various ways of addressing this problem will occur to persons skilled in the art. The use of three piston-cylinder assemblies in each of the pump 410 and motor 512 such that force is applied sequentially advantageously addressed this problem.

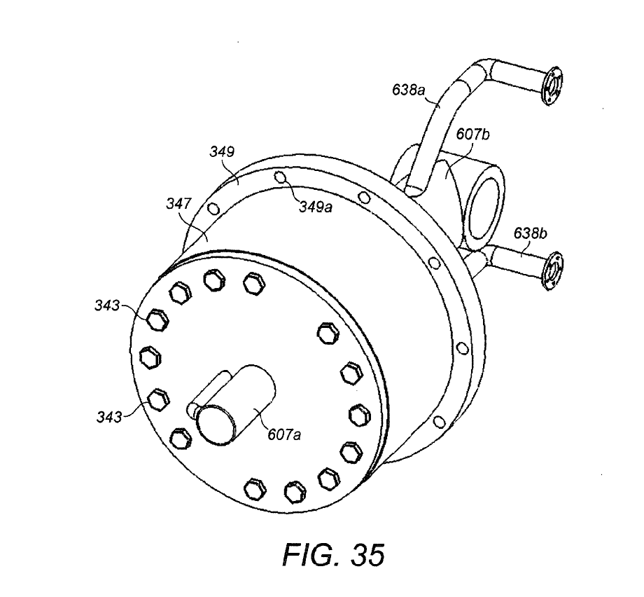

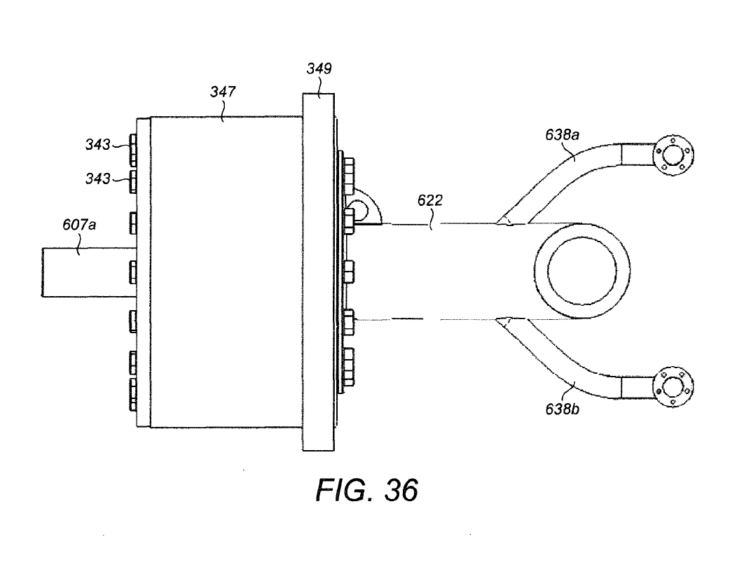

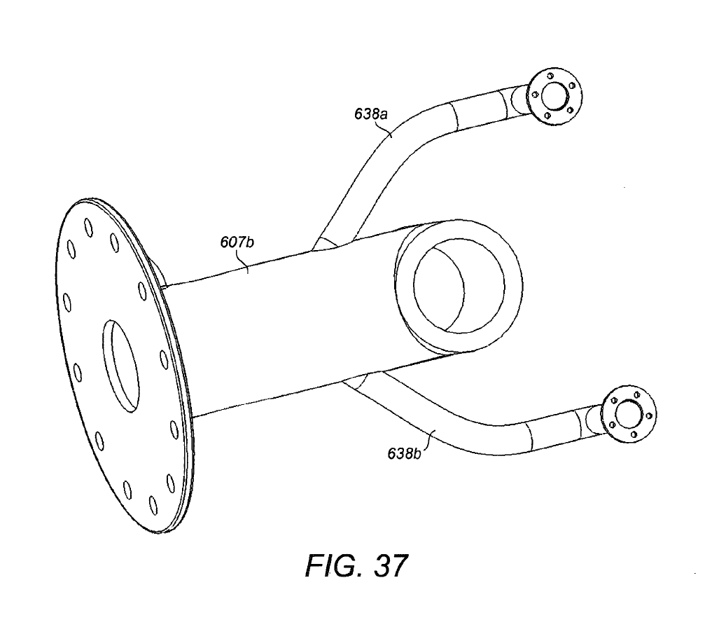

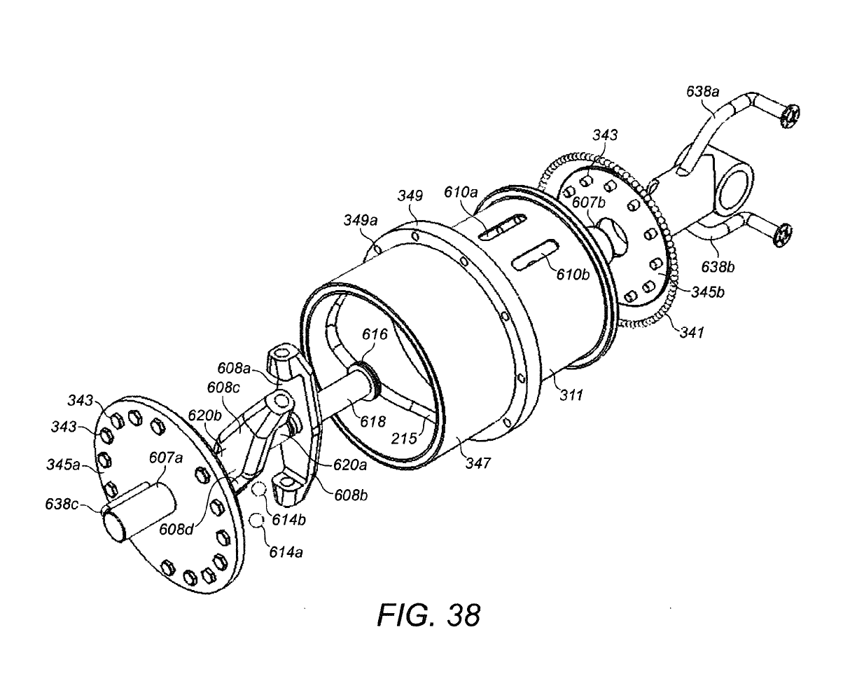

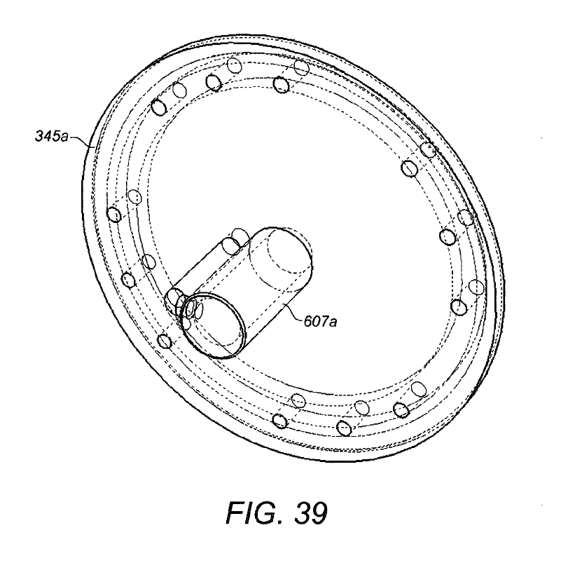

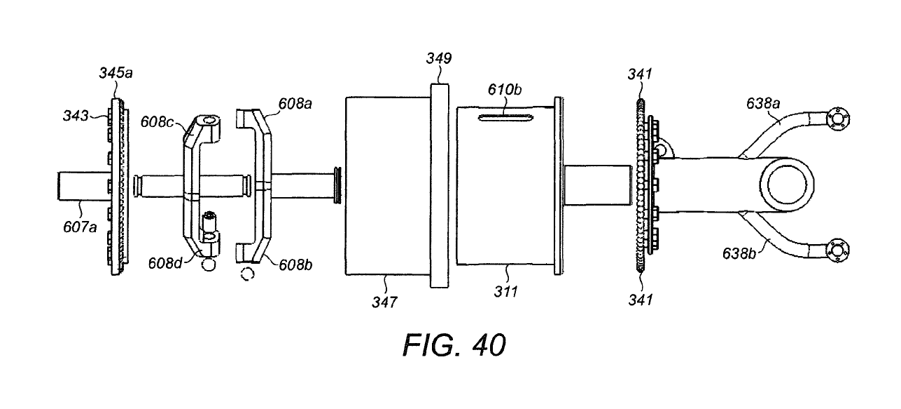

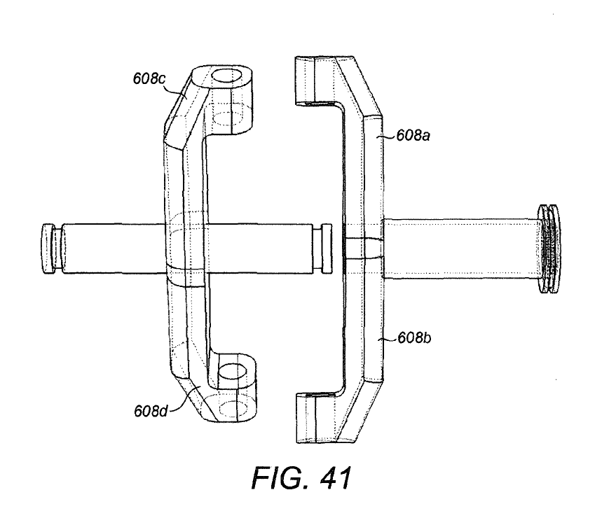

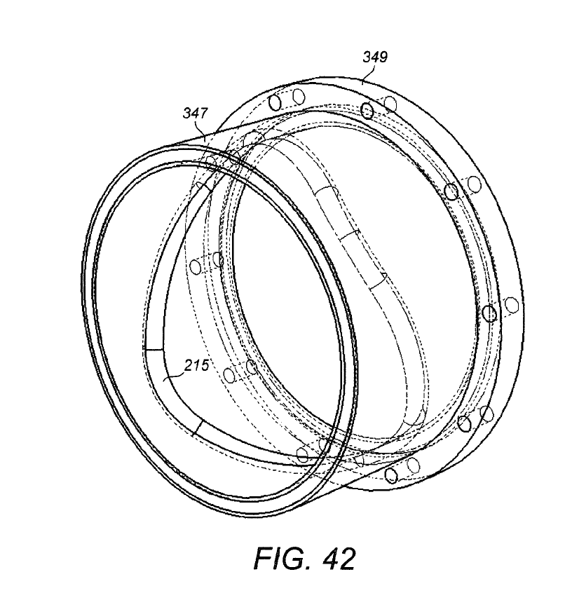

Another embodiment will now be described with reference to FIGS. 35 to 42. In this embodiment, a motor 610 for a hydraulic transmission system is provided. The motor 610 is a variant on the motors 210 and 310 described above. A pump having the same features and operating in the same manner as already described may be used with the motor 610, as may the fluid transmission system. The following description will focus on the differences between the motor of the embodiment and those already described.

In this embodiment, first and second fluid transmission lines 638a, 638b conveniently connect to the fluid motor 612 at the same side. A tubing that is not shown connects the first transmission line 638a extends to the fluid chamber of the first cylinder 607a, the tubing passing through the interior of the fluid motor. The tubing operatively attaches to a tubular piece 638c leading to the second cylinder 607b The second transmission line 638b provides fluid to the fluid chamber of the second cylinder 607b.

Also, the embodiment of FIGS. 22 to 24 has radially extending lobes 208a, 208b together extending across the diameter of the interior of the cylindrical drive member 347, and the embodiment of FIGS. 35 to 42 includes two comparable members. These members, each in the form of a pair of arms 608a-d, each extend across the diameter of the interior of the drive member 347. Each has a mounted bearing 614a, 614b at an end thereof for engaging in the groove 215. The cylindrical support sleeve 311 is modified to have two pairs of slots 610a, 610b through which the bearings 209 extends to engage in the groove 215. The members are offset from one another by less than 45 degrees. The provision of these two members with the angular offset prevents a wheel accidentally rotating back and forth rather than in a single direction.

The first pair of arms 608a, 608b are radially mounted on a sleeve 618 having an annular flange 616 at an end thereof nearest the second cylinder 607b. The sleeve 618 can reciprocate in the second cylinder 607b. Pressure acting on the flange serves to push the sleeve and thus the sleeve acts as a piston.

The second pair of arms 608c,d is radially mounted on a piston piece 620a, 620b that sealingly engages in the sleeve. The sleeve also acts as a cylinder, and fluid in the sleeve pushes the piston piece 620a at a first end thereof. A second end of the piston piece 620a is located for reciprocating movement in the first cylinder 607a. Alternating pressure on the first and second ends 620a, b of the piston piece causes the second pair of arms to reciprocate. The result of the arrangement of the sleeve and the piston piece is that movement of one of the pairs of arms follows the other. The first and second ends 620a,b have circumferential grooves therein in which seals (not shown) are located for sealing in the first cylinder 607a and the sleeve 618.

The part 622 is for fixedly attached to a vehicle to attach the motor thereto.

In operation, when fluid is pushed into the first cylinder 607a, the second end 620b of the piston piece is pushed. When fluid is pushed into the second cylinder 607b, the first end 620a of the piston piece is pushed into the sleeve 618.

When fluid is pushed into the second cylinder 607b, the sleeve 618 is pushed by action on the flange, and also the piston piece 620a,b is pushed, due to the fluid within the sleeve 618 acting on the first end of the piston piece 620a. By such an arrangement, a wheel can be rotated in a single predetermined direction.

All of the parts described herein can be manufactured in accordance with conventional techniques known to the suitably skilled person.

It will be appreciated by the person skilled in the art that various modifications may be made to embodiments of the present invention.

It should be understood that in any of the hydraulic systems described above, gas may be used rather than liquid, thus making the system a pneumatic transmission system.

It should be understood that the arrangement of the projecting linkage and the non-linear groove can, in embodiments, be reversed. For example, in the embodiment described with reference to FIGS. 2 to 6, a linkage such as a ball bearing or nub may extend from the first piston 116, and the non-linear groove can extending circumferentially around the inside of a sleeve/body portion of the first cylinder 118. The non-linear groove is non-linear with respect to a notional line forming a circle; the non-linear groove may be elliptical.

While the piston means described in the embodiments reciprocates along a linear path, it should be understood that in some embodiments, and dependent on application, the path may be curved. Parts can be designed where appropriate to accommodate the curved path.

Also, in some embodiments, the axis of the piston means and the axis of relative rotation of the projection and the non-linear groove may be spaced.

The applicant hereby discloses in isolation each individual feature or step described herein and any combination of two or more such features, to the extent that such features or steps or combinations of features and/or steps are capable of being carried out based on the present specification as a whole in the light of the common general knowledge of a person skilled in the art, irrespective of whether such features or steps or combinations of features and/or steps solve any problems disclosed herein, and without limitation to the scope of the claims. The applicant indicates that aspects of the present invention may consist of any such individual feature or step or combination of features and/or steps. In view of the foregoing description it will be evident to a person skilled in the art that various modifications may be made within the scope of the invention.

1. A fluid motor for a pneumatic or hydraulic drive system, comprising:
at least one piston means;
at least one cylinder means, wherein the or each cylinder means and an end of the or each piston means located in a corresponding one of the cylinder means defines a chamber, and wherein the or each cylinder means is operatively coupled to a pressure generation and transmission system arranged to cause alternating flow of fluid into and out of the or each chamber, thereby to cause reciprocating movement of the piston means;
motion conversion means comprising:
at least one portion extending continuously and circumferentially around a central axis and extending in part longitudinally relative to the central axis, and
at least one linking means, wherein the at least one portion and the or each linking means are relatively rotatable about the central axis and wherein a one of the at least one linking means or the at least one portion is coupled to the at least one piston means so that reciprocating movement of the at least one piston means causes reciprocating movement thereof, wherein the at least one linking means and the at least one portion are configured to cooperate whereby the reciprocating movement of the at least one piston means causes relative rotary motion of the other of the portion and the linking means about said central axis;
a sleeve means rotatably mounted about the central axis, wherein the other of the portion and the at least one linking means is coupled to the sleeve means so that the reciprocating movement of the at least one piston means causes rotary motion of the sleeve means about the central axis.

2. The fluid motor of claim 1, further comprising movement restricting means preventing rotary motion of the one of the at least one portion and the at least one linking means about the central axis, and preventing reciprocating movement of the other of the at least one linking means and the at least one portion, and the sleeve means.

3. The fluid motor of claim 1 or claim 2, wherein the at least one portion is coupled to the sleeve means and is located in an inner surface of the sleeve means.

4. The fluid motor of any one of claims 1 to 3, wherein the sleeve means is adapted for coupling to an object to be rotated.

5. The fluid motor of claim 4, wherein the at least one cylinder means is coupled to a frame of a vehicle to prevent movement thereof, wherein the sleeve means is adapted for coupling to a wheel of the vehicle.

6. The fluid motor of any one of the preceding claims, wherein the at least one piston means is arranged to reciprocate on the central axis, wherein the at least one portion is coupled to the at least one piston means and extends around the at least one piston means coaxially therewith, wherein the at least one linking means projects from an inner surface of the sleeve means to cooperate with the at least one portion.

7. The fluid motor of any one of the preceding claims, wherein the at least one piston comprises a plurality of the piston means, wherein a predetermined pattern of reciprocating movement of the pistons means caused by the pressure generation and transmission system causes the at least one linking means and the at least one portion to so cooperate.

8. The fluid motor of claim 7, wherein two piston means reciprocate along the same axis in an alternating manner, wherein alternating fluid flow into and out of the corresponding two chamber means causes said pattern.

9. The fluid motor of claim 7 or claim 8, wherein the at least one linking means comprises a plurality of the linking means each coupled to a one of the piston means, wherein the linking means are angularly spaced relative to the central axis.

10. The fluid motor of claim 7 or claim 9, wherein plurality of piston means is three piston means.

11. A fluid pump, comprising:
a drive shaft rotatable about an axis thereof;
at least one piston means;
a sleeve means rotatable about a central axis and mounted around the at least one piston means;
motion conversion means comprising:
at least one portion extending continuously and circumferentially around the central axis and extending in part longitudinally relative to the central axis, and
at least one linking means, wherein the at least one portion and the at least one linking means are arranged for relative rotation about the central axis, wherein the at least one linking means and the at least one portion are configured to cooperate so that relative rotation causes reciprocating movement of the at least one piston, wherein a one of the at least one portion and the at least one linking means is coupled to the sleeve means whereby rotation of the sleeve means causes rotation thereof about the central axis;
for the or each piston means, a cylinder means, wherein an end of the or each piston means and the or each corresponding cylinder means define a chamber, and wherein the or each chamber can be operatively coupled to a pressure transmission system to permit alternating flow of fluid into and out of the or each chamber, wherein the reciprocating movement of the at least one piston means causes fluid flow into and out of the or each chamber;
wherein the or each piston means is coupled to the other of the portion and the at least one linking means, whereby rotation of sleeve means causes the reciprocating movement of the piston means.

12. The fluid pump of claim 11, further comprising movement restricting means preventing rotary motion of the other of the portion and the linking means about the central axis, and preventing reciprocating movement of one of the linking means and the portion.

13. The fluid pump of claim 11 or claim 12, wherein the at least one piston means comprises two piston means arranged for reciprocating movement on the same axis and to alternately drive fluid out of the respective chambers thereof.

14. The fluid pump of claims 11 to 13, wherein the at least one piston means is arranged for reciprocating movement substantially on or parallel to the central axis,

15. The fluid pump of any one of claims 11 to 14, wherein the at least one cylinder means is fixedly coupled to a frame of a machine or vehicle to prevent rotation about said central axis.

16. The fluid pump of any one of claims 11 to 14, wherein the portion is coupled to the sleeve means and is located in an inner surface thereof.

17. The fluid pump of any one of claims 11 to 16, wherein the portion is a non-linear groove, and the linking means comprises a projection for engaging in the non-linear groove.

18. The fluid pump of claim 17, wherein the projection comprises a bearing and means for retaining the bearing partially in the groove.

19. The fluid pump of any one of claims 11 to 18, configured for location in a bottom bracket shell of a machine or vehicle.

20. A fluid motor for a pneumatic or hydraulic drive system, comprising:
at least one piston means arranged on a central axis;
at least one cylinder means, wherein the or each cylinder means and an end of the or each piston means located in a corresponding one of the cylinder means defines a chamber, and wherein the or each cylinder means is operatively coupled to a pressure generation and transmission system arranged to cause flow of fluid into the respective chamber and enable flow of fluid out of said chamber, thereby to cause reciprocating movement of the piston means, wherein the or each piston means is arranged to rotate in the respective cylinder means about said central axis;
motion conversion means comprising:
at least one portion extending continuously and circumferentially around a central axis and extending in part longitudinally relative to the central axis, and
at least one linking means, wherein the at least one portion and the or each linking means are relatively rotatable about the central axis and wherein a one of either the at least one linking means or the portion is coupled to the at least one piston means so that reciprocating movement of the at least one piston means causes reciprocating movement thereof, wherein the at least one linking means, the portion are configured to cooperate whereby the reciprocating movement of the at least one piston means causes relative rotary motion of the other of the portion and the linking means about said central axis;
a drive shaft disposed coaxially with the at least one piston means, wherein the drive shaft is coupled to the at least one piston means so that the relative rotary motion causes corresponding rotation of the drive shaft and reciprocating movement of the piston means relative to the drive shaft on the central axis is permitted.

21. The fluid motor of claim 20, further comprising movement restricting means preventing rotary motion of the one of the portion and the at least one linking means about the central axis, and preventing reciprocating movement of the other of the at least one linking means and the portion, and the sleeve means.

22. The fluid motor of any one of claims 20 to 21, wherein a double-ended piston comprises two of the piston means, the double-ended piston being arranged for reciprocating movement on the central axis.

23. A fluid motor for a pneumatic or hydraulic drive system, comprising:
at least one piston means arranged on a central axis;
at least one cylinder means, wherein the or each cylinder means and an end of the or each piston means located in a corresponding one of the cylinder means defines a chamber, and wherein the or each cylinder means is operatively coupled to a pressure generation and transmission system arranged to cause flow of fluid into the respective chamber and enable flow of fluid out of said chamber, thereby to cause reciprocating movement of the piston means, wherein the or each piston means is arranged to rotate in the respective cylinder means about said central axis;
motion conversion means comprising:
at least one groove extending continuously and circumferentially around a central axis and extending in part longitudinally relative to the central axis, and
at least one linking means, each linking means comprising a projection for engaging in the groove, wherein the at least one groove and the or each projection are relatively rotatable about the central axis and wherein a one of either the at least one projection or the groove is coupled to the at least one piston means so that reciprocating movement of the at least one piston means causes reciprocating movement thereof, wherein the at least one projection, the groove are configured to cooperate whereby the reciprocating movement of the at least one piston means causes relative rotary motion of the other of the groove and the projection about said central axis.

24. The fluid motor of claim 23, further comprising movement restricting means preventing rotary motion of the one of the portion and the at least one linking means about the central axis, and preventing reciprocating movement of the other of the at least one linking means and the portion, and the sleeve means.

25. The fluid motor of any one of claims 23 to 24, wherein a double-ended piston comprises two of the piston means, the double-ended piston being arranged for reciprocating movement on the central axis.

26. A hydraulic or pneumatic drive system comprising:
a) a fluid motor;
b) a fluid transmission system operatively connected to the fluid motor;
c) a fluid pump to which the pressure transmission system is also operatively connected, the fluid pump comprising:
a drive shaft rotatable about an axis thereof;
at least one piston means;
motion conversion means comprising at least one portion extending continuously and circumferentially around a central axis and in part longitudinally relative to said central axis, and at least one linking means, wherein the at least one portion and the at least one linking means are arranged for relative rotation about the central axis, wherein the at least one linking means and the at least one portion are configured to cooperate so that relative rotation causes relative reciprocating movement along the central axis, wherein a one of the at least one portion or the at least one linking means is coupled to the drive shaft whereby rotation of the drive shaft causes rotation of the one about the central axis;
for the or each piston means, a cylinder means, wherein the or each cylinder means and an end of the or each piston means located in the respective cylinder means defines a chamber, and wherein the or each cylinder means is coupled to the fluid transmission system to permit alternating flow of fluid into and out of the or each chamber, wherein the or each piston means is arranged for reciprocating movement on or parallel to the central axis to cause fluid flow into and out of the corresponding chamber;
wherein the piston means is coupled to the other of the at least one portion and the linking means so that rotation of the one of the at least one portion and the linking means causes the reciprocating movement of the or each piston means in the corresponding cylinder means.

27. The drive system of claim 26, wherein the fluid pump comprises a double ended piston comprises two piston means, wherein the reciprocating movement of the piston means causes fluid flow into and out of each chamber.

28. The drive system of any one of claim 21 or claim 22, wherein the piston means is arranged for reciprocating movement along said central axis and the axis of the drive shaft is also said central axis.

29. The drive system of claims 26 to 28, wherein the at least one cylinder means is fixedly coupled to a frame of a machine or vehicle to prevent rotation about said central axis.

30. The drive system of any one of claims 26 to 29, wherein the portion includes a non-linear groove, and the linking means comprises a projection for engaging in the non-linear groove.

31. The drive system of any one of claims 26 to 29, wherein the groove is a non-linear groove.

32. The drive system of claim 31, wherein the projection comprises a bearing and means for retaining the bearing partially in the groove.

33. The drive system of any one of claims 26 to 32, wherein the one of the linking means and the portion is coupled to the at least one piston means, wherein the at least one piston means is coupled to the drive shaft so that rotation of the drive shaft causes corresponding rotary motion of the at least one piston means about its axis and relative reciprocating movement of the at least one piston means on the drive shaft is permitted, wherein the rotary motion of the drive shaft causes rotary motion of the piston means and thus the one of the linking means and the portion, which causes reciprocating movement of the piston means on the drive shaft.

34. The drive system of any one of claims 26 to 33, wherein the at least one piston means has a passage therethrough, the drive shaft being sealingly mounted through an aperture in an end of the at least one cylinder means and extending into said passage, wherein the drive shaft and the passage are together configured to so couple the drive shaft and the at least one piston means.

35. The drive system of any one of claims 26 to 34, wherein the non-linear part is located in a sleeve means having a cylindrical inner surface having the central axis as the central axis thereof and extending around the piston means.

36. The drive system of any one of claims 26 to 35, wherein the fluid pump further comprises movement restricting means preventing rotary motion of the other of the portion and the linking means about the central axis, preventing reciprocating movement of a first of the linking means and the portion and permitting the reciprocating movement of a second of the linking means and the portion.

37. A hydraulic or pneumatic drive system comprising:
a) the fluid pump of any one of claims 11 to 18;
b) a fluid transmission system
c) a fluid motor, wherein the fluid transmission system is operatively coupled to the or each chamber of the fluid pump and to the fluid motor, wherein the fluid motor is configured to be driven by the fluid pump.

38. A motor for a hydraulic or pneumatic drive system, comprising:
at least two piston means;
for each piston means, a cylinder means, wherein each cylinder means and the associated piston means define chamber, and wherein each cylinder means is operatively coupled to a fluid pump to cause alternating or sequential flow of fluid into and out of each chamber, thereby to cause reciprocating movement of each piston means;
motion conversion means comprising:
at least one portion extending continuously and circumferentially around a central axis and extending in part longitudinally relative to the central axis, and
for each piston means, a linking means coupled to the respective piston means, so that reciprocating movement of each piston means causes reciprocating movement of the corresponding linking means, wherein the at least one portion and each linking means are relatively rotatable about the central axis, wherein the at least two linking means and the at least one portion are configured to cooperate whereby the reciprocating movement of each piston means causes relative rotary motion of the at least one portion about said central axis, wherein the at least two linking means are angularly spaced about the central axis.

39. The fluid motor of claim 38, further comprising movement restricting means preventing rotary motion of the at least two linking means about the central axis, and preventing reciprocating movement of the at least one portion and the sleeve means.

40. The motor of claim 38 or claim 39, further comprising a sleeve means rotatably mounted about the central axis, wherein the at least one portion is coupled to the sleeve means so that the reciprocating movement of the at least two piston means causes rotary motion of the sleeve means about the central axis.

41. The fluid motor of claim 40, wherein the at least one portion is coupled to the sleeve means and is located in an inner surface of the sleeve means.

42. The fluid motor of any one of claims 38 to 40, wherein the sleeve means is adapted for coupling to an object to be rotated.

43. The fluid motor of any one of claims 38 to 42, wherein the at least two cylinder means are coupled to a frame of a vehicle to prevent movement thereof, wherein the sleeve means is adapted for coupling to a wheel of the vehicle.

44. The fluid motor of any one of claims 38 to 43, wherein the at least two piston means is at least three piston means.

45. The fluid motor of claim 44, wherein the at least three pistons are arranged to reciprocate on substantially parallel axes, said axes being parallel to the central axis.

46. The fluid motor of any one of claims 38 to 45, wherein the at least three linking means and the at least one portion are configured so that the at least one portion rotates about the central axis in single predetermined direction.

47. The fluid motor of any one of claims 38 to 46, wherein the portion is a non-linear groove, and each linking means comprises a projection for engaging in the groove, the groove being non-linear relative to a direction radial to the central axis.

48. The fluid motor of claim 47, wherein the groove is elliptical.

49. The fluid motor of any one of claims 38 to 48, wherein the at least two linking means comprise an arm for engaging with the portion.

50. The fluid motor of claim 49, wherein the arm comprises a bearing, the bearing engaging with the portion.

52. A fluid motor for a pneumatic or hydraulic drive system, comprising:
at least one piston means;
at least one cylinder means, wherein the or each cylinder means and an end of the or each piston means located in corresponding cylinder means defines a chamber, and wherein the or each cylinder means can be operatively coupled to a fluid pump to cause flow of fluid into and out of the or each chamber, thereby to cause reciprocating movement of the at least one piston means, wherein the or each piston means is arranged to rotate in the respective cylinder means about said central axis;
motion conversion means comprising:
at least one portion extending continuously and circumferentially around the central axis and extending in part longitudinally relative to the central axis, and
at least one linking means, each linking means for engaging with the at least one portion, wherein the at least one portion and the or each linking means are relatively rotatable about the central axis and wherein a one of the at least one linking means and the at least one portion is coupled to the at least one piston means so that reciprocating movement of the at least one piston means causes reciprocating movement thereof, wherein the at least one linking means and the at least one groove are configured to cooperate whereby the reciprocating movement of the at least one piston means causes relative rotary motion of the other of the portion and the linking means about said central axis.

53. The fluid motor of any one of claims 1 to 10, 20 to 25, 38 to 50 and 52 wherein the portion is a groove, and the or each linking means comprises a projection for engaging in the groove.

54. The fluid motor of claim 53, wherein the portion is a non-linear groove relative to a direction radial to the central axis.

55. The fluid motor of claim 53 or claim 54, wherein the groove is elliptical.

56. The fluid motor of any one of claims 57 to 59, wherein the or each linking means is a projection.

57. The fluid motor of claim 56, wherein the projection comprises a bearing.

58. The drive system of any one of claims 26 to 37, wherein the fluid motor is of any one of claims 1 to 10, 22 to 25, 38 to 59 and 52 to 57.

59. A hydraulic or pneumatic drive system comprising:
a) a fluid pump;
b) the fluid motor of any one of claims 1 to 10, 20 to 25 and 38 to 50 and 52 to 57.
c) a fluid transmission system operatively coupled to the fluid pump and to the at least one chamber of the fluid motor, wherein the fluid pump is arranged to cause flow of fluid into the at least one chamber to cause reciprocating movement of the piston means.

60. A pedal-driven vehicle or machine comprising a hydraulic or pneumatic drive system, comprising:
a) a fluid pump comprising a drive shaft mounted in a bracket and rotatable about an axis by a pedaling action;
a cam mounted on the drive shaft;
at least one piston means;
for the or each piston means, a cylinder means, wherein an end of the or each piston means and the corresponding cylinder means define a chamber, wherein the piston means is arranged relative to the cam so that rotation of the cam with the drive shaft causes reciprocating movement of the piston means in the cylinder means;
b) a fluid motor configured to drive a wheel;
c) a transmission system operatively coupled to the or each chamber and to the fluid motor, wherein the reciprocating movement of the at least one piston means causes the fluid motor to drive the wheel.

61. The vehicle or machine of claim 60, wherein the cam is elliptical.

62. The vehicle or machine of claim 60 or claim 61, wherein the fluid pump comprises a plurality of piston means each having an associated cylinder means, wherein each cylinder is fixedly mounted on a support fixedly coupled to the frame of the bicycle or machine, wherein each cylinder means is disposed to enable reciprocating movement of the corresponding piston radially with respect to the axis of the drive shaft, wherein the cam is arranged to consecutively push each of the piston means into the corresponding cylinder means.

63. The vehicle or machine of claim 62, wherein the plurality of piston means comprises three pistons means

64. The vehicle of any one of claims 60 to 62, wherein the bracket is a standard bottom bracket shell.

65. The vehicle or machine of any one of the preceding claims, wherein each drive shaft end is operatively attached to a first end of a respective crank arm, wherein a second end of each crank arm is operatively attached to a respective pedal.

66. The vehicle or machine of any one of the preceding claims, comprising:
a) the fluid pump of any one of claims 60 to 65;
b) a fluid transmission system
c) a fluid motor, wherein the fluid transmission system is operatively coupled to each chamber of the fluid pump and to the fluid motor, wherein the fluid motor is configured to be driven by the fluid pump.

67. A hub assembly for a wheel, comprising the fluid motor of any one of claims 1 to 10, 20 to 25, 38 to 50 and 52 to 57

68. The fluid pump of any one of claims 11 to 18, configured for location in a bottom bracket shell of a machine or vehicle.

69. A pedal driven machine or vehicle comprising the system of any one of claims 26 to 37, 58 and 59, wherein each drive shaft end is operatively attached to a first end of a respective crank arm, wherein a second end of each crank arm is operatively attached to a respective pedal.
